(19) United States
(12) Patent Application Publication
(10) Pub. No.: US 2014/0168463 A1
(43) Pub. Date: Jun. 19, 2014

(54) IMAGE-PROCESSING DEVICE AND IMAGING APPARATUS

(71) Applicant: Ryohsuke TAMURA, Kawasaki-shi (JP)

(72) Inventor: Ryohsuke TAMURA, Kawasaki-shi (JP)

(21) Appl. No.: 14/103,117

(22) Filed: Dec. 11, 2013

(30) Foreign Application Priority Data
Dec. 14, 2012 (JP) 2012-273251

(51) Int. Cl. H04N 9/73

(52) U.S. Cl. CPC H04N 9/735
USPC 348/223.1

(57) ABSTRACT

An image-processing device that adjusts white balance of an image includes a region setter that classifies the image by color temperature and sets a plurality of regions thereto; and a white balance controller that generates a white-balance-adjusted image based on color temperature of a target region of the regions from the image, wherein by targeting all of the regions set by the region setter, the white balance controller generates white-balance-adjusted images as many as the number equal to the number of the regions set by the region setter from the image.

### CROSS-REFERENCE TO RELATED APPLICATIONS

The present application is based on and claims priority from Japanese Patent Application Number 2012-273251, filed Dec. 14, 2012, the disclosure of which is hereby incorporated by reference herein in its entirety.

### BACKGROUND

The present invention relates to an image-processing device that generates an image in which white balance is adjusted (white-balance-adjusted image), and to an imaging apparatus including the image-processing device.

It is known that in an image obtained (photographed) by an imaging apparatus, or the like, the color of an entire image is adjusted by adjusting white balance based on color temperature of light that illuminates a photographic subject. Additionally, it has been proposed to generate an image in which white balance is adjusted based on color temperature that is set with respect to the image, and generate an image in which white balance is adjusted based on a higher color temperature and a lower color temperature than the set color temperature, respectively (so-called white balance bracket). However, in this method, color temperature that is firstly calculated is taken as reference, a high color temperature and a low color temperature are calculated, and a white-balance-adjusted image is generated based on each of the color temperatures, and therefore, an image having color corresponding to a photographer's intention is not always obtained. This tends to occur, for example, in a case where regions illuminated by light of different color temperatures exist in an image, that is, in a case where regions of different color temperatures exist.

Furthermore, as a white balance correction method, there is a method that makes it possible for a color shift not to occur throughout the entire region of an image in which regions of different color temperatures exist, or the like (for example, see Japanese Patent Application Publication number 2005-347811). In this method, per coefficient block obtained by dividing an image, a correction coefficient with respect to a center pixel of each coefficient block is calculated, a correction coefficient with respect to a non-center pixel other than the center pixel in each coefficient block is individually calculated by linear interpolation based on a distance between the non-center pixel and each center pixel from correction coefficients with respect to surrounding center pixels. And by multiplying all the pixels of a center pixel and non-center pixels by the calculated correction coefficient, respectively, white balance of each pixel, that is, white balance of the entire image is adjusted. Thus, it is possible to adjust white balance to the color temperature set with respect to each pixel, and therefore, even in a case where regions of different color temperatures exist in the image, it is possible to obtain an image having appropriate color throughout. Additionally, by calculating a correction coefficient of a non-center pixel by linear interpolation based on a distance between the non-center pixel and each center pixel, even in a case where regions of different color temperatures exist, it is possible to obtain an image in which the occurrence of a color shift based on a difference of a correction coefficient in a border between regions of different color temperatures is prevented.

### SUMMARY

However, in the above-described white balance correction method, by setting a correction coefficient of a center pixel per coefficient block, and calculating a correction coefficient of a non-center pixel by linear interpolation based on a distance between the non-center pixel and each center pixel, it is not possible to obtain an image appropriately adjusted based on color temperature of each region, in a case where regions of different color temperatures exist in the image.

An object of the present invention is to provide an image-processing device that, in a case where regions of different color temperatures exist in an image, obtains an image appropriately adjusted based on color temperature of each region.

In order to achieve the above object, an embodiment of the present invention provides: an image-processing device that adjusts white balance of an image, comprising a region setter that classifies the image by color temperature and sets a plurality of regions thereto; and a white balance controller that generates a white-balance-adjusted image based on color temperature of a target region of the regions from the image, wherein by targeting all of the regions set by the region setter, the white balance controller generates white-balance-adjusted images as many as the number equal to the number of the regions set by the region setter from the image.

In order to achieve the above object, an embodiment of the present invention provides: an image-processing device that adjusts white balance of an image, comprising a region setter that classifies the image by color temperature, and sets a plurality of regions thereto; and a white balance controller that generates a white-balance-adjusted image based on color temperature of a target region of the regions from the image, wherein by targeting at least two regions of the regions set by the region setter, the white balance controller generates at least two white-balance-adjusted images from the image.

In order to achieve the above object, an embodiment of the present invention provides: an imaging apparatus, which has an image-processing device that adjusts white balance, the imaging apparatus obtaining a first image to perform a live-view display, and obtaining a second image in accordance with a photographing operation, comprising: a region setter that classifies the first image by color temperature, and sets a plurality of regions thereto, and a white balance controller that generates a white-balance-adjusted image based on the second image, wherein the white balance controller targets at least two regions of the regions set by the region setter for white balance control, and based on color temperature of regions in the second image corresponding to the at least two target regions, generates at least two white-balance-adjusted images from the second image.

### BRIEF DESCRIPTION OF THE DRAWINGS

FIG. 1 is an explanatory diagram illustrating a control block in an image-processing device 10 as an example of an image-processing device according to an embodiment of the present invention.

FIG. 2 is an explanatory diagram illustrating an image 21 as an example of an image inputted (input image) to the image-processing device 10.

FIG. 3 is an explanatory diagram explaining a state of generating 256 blocks 22 in the image 21.

FIG. 4 is an explanatory diagram explaining a state where a first color temperature region R1, a second color temperature region R2, and a third color temperature region R3 are set in the image 21.

FIG. 5 is an explanatory diagram illustrating an example of white detection frames in a chromatic coordinate (color space) where a horizontal axis is taken as G/R, and a vertical axis is taken as G/B.

FIG. 6 is an explanatory diagram illustrating distribution of WB (white balance) evaluation values of each block 22 of the image 21, and on the left, the image 21 of FIG. 2 is illustrated, and on the right, the white detection frames illustrated of FIG. 5 are illustrated.

FIG. 7 is an explanatory diagram illustrating a white detection frame of incandescent light and a white detection frame of an evening sun that are assigned to the first color temperature region R1 and stored.

FIG. 8 is an explanatory diagram illustrating a white detection frame of white fluorescent light that is assigned to the second color temperature region R2 and stored.

FIG. 9 is an explanatory diagram illustrating a white detection frame of a shade that is assigned to the third color temperature region R3 and stored.

FIG. 10 is a flow diagram illustrating an example of a control process in the image-processing device 10 in a case of performing WB (white balance) control according to an embodiment of the present invention.

Each of FIGS. 11A, 11B, and 11C is an explanatory diagram explaining a structure of an imaging apparatus 30 of Example 2. FIGS. 11A, 11B, and 11C illustrate a front view, a top view, and a rear view, respectively.

FIG. 12 is a block diagram illustrating a system configuration of the imaging apparatus 30.

FIG. 13 is an explanatory diagram illustrating a control block in an image-processing device 102 of Example 2.

FIG. 14 is an explanatory diagram illustrating a state where a photographing image is displayed on a liquid crystal display (LCD) monitor 38 by a live-view operation.

FIG. 15 is a flow diagram illustrating an example of a control process in the image-processing device 102 (controller 69) in a case of performing WB (white balance) control according to an embodiment of the present invention.

FIG. 16 is an explanatory diagram explaining a state where a desired position is selected in the image 21 displayed on the LCD monitor 38.

### DETAILED DESCRIPTION OF THE PREFERRED EMBODIMENTS

Hereinafter, each example of an image-processing device and an imaging apparatus according to embodiments of the present invention will be explained with reference to drawings.

### Example 1

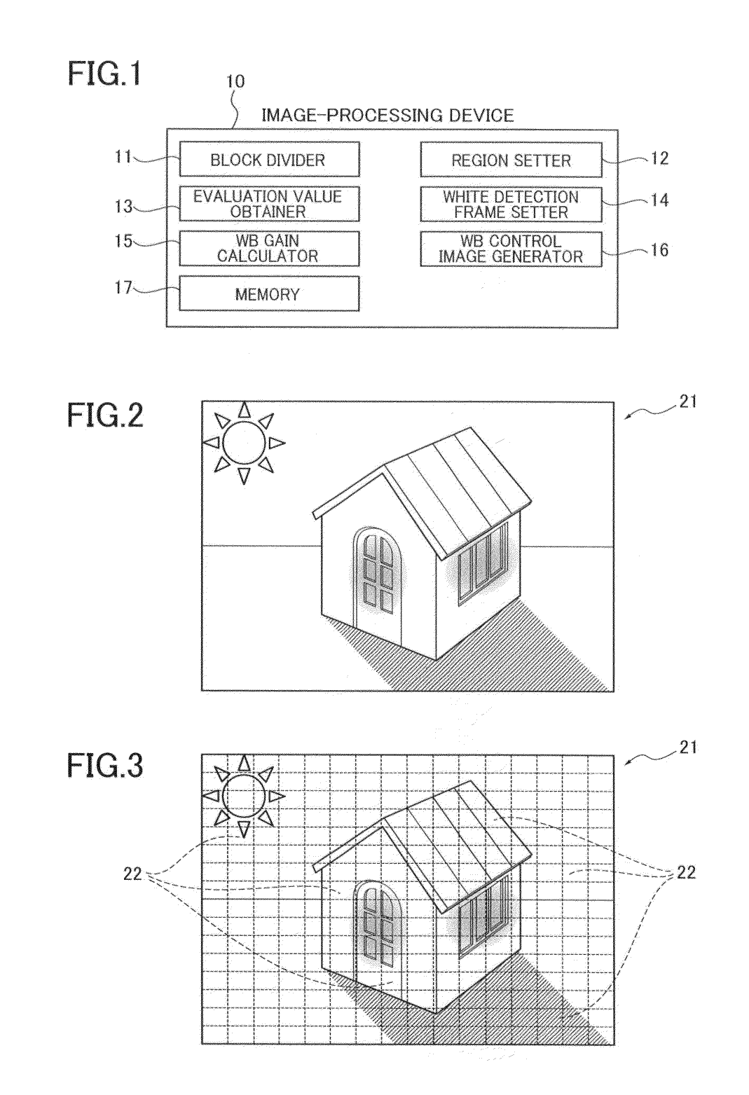

A schematic structure of an image-processing device 10 as an example of an image-processing device according to an embodiment of the present invention will be explained with reference to FIGS. 1 to 10. In Example 1, as an example of an input image, as illustrated in FIG. 2, an image 21 in which there is a house on a white ground under an evening sun is used. In the image 21, a portion of a shadow of the house on the ground exists, and light of white fluorescent light provided in the house leaks from a door and a window of the house (the same applies to FIGS. 3, 4, and 6).

In a case where regions of a plurality of color temperatures exist in an image (on-screen image), it is possible for the image-processing device 10 according to an embodiment of the present invention illustrated in FIG. 1 to obtain images, each one of which is an image appropriately adjusted based on any one of the plurality of the color temperatures, as many as the number of the plurality of the color temperatures that exist in the image. Here, in a case where regions illuminated by light of different color temperatures exist in the image (on-screen image), that is, in a case where regions different in color temperature exist in the image (on-screen image), a region of a color temperature indicates a region where the image (on-screen image) is classified (divided) by color temperature. As a case where regions different in color temperature exist in the image (on-screen image), there are a scene where regions different in color temperature exist even in a case of a single light source (sunlight, for example), and a scene where regions illuminated by light of different light sources exist. As a case of the former scene (single light source), for example, there is a scene of a place in the sun and a place in the shade under the sunlight. As a case of the latter scene (a plurality of light sources), for example, there is a scene where a photographic subject (main photographic subject, for example) which is illuminated by a flash, and a photographic subject (background, for example) to which the flash does not reach and which is illuminated by a different light source exist in a case of flash photographing.

The image-processing device 10 generates an image in which white balance (hereinafter, also referred to as WB) is adjusted (a white-balance(WB)-adjusted image) from an input image (referred to as WB control), and outputs it. The image-processing device 10, in a case where regions of a plurality of color temperatures exist in the input image, by performing an image generation process where white balance is adjusted based on color temperature of a target region from the input image with respect to all of the regions as a target, generates white-balance-adjusted images as many as the number equal to the number of the regions that exist, and appropriately outputs each generated image. Although illustration is omitted, the image-processing device 10 includes a substrate on which a plurality of electronic components such as a capacitor, a resistor, and the like are mounted, and performs various processes including WB control according to an embodiment of the present invention by a program stored on a later-described memory 17. The image-processing device 10 can be included in a digital photo printer, an imaging apparatus, or a terminal device of a personal computer, and the like. Additionally, although illustration is omitted, an input image can be an image photographed by any imaging apparatuses, or an image read by an image reader such as a scanner, and the like. In a case where the image-processing device 10 is included in an imaging apparatus, it is needless to say that an image photographed by the imaging apparatus also can be included in the input image.

As illustrated in FIG. 1, in order to perform a WB control process, the image-processing device 10 includes a block divider 11, a region setter 12, an evaluation value obtainer 13, a white detection frame setter 14, a WB gain calculator 15, a WB control image generator 16, and a memory 17. In Example 1, each of the above in order to perform the WB control process is configured with a program. Each of the above can be individually configured with an electronic circuit (calculation circuit), if it is possible to perform the following processes. The image-processing device 10 includes various parts in order to perform other image processing control, image input-output control, and the like; however, they have nothing to do with WB control according to an embodiment of the present invention, and are general structures, and therefore, they are omitted.

The block divider 11 divides an input image (image data) into a plurality of blocks. The number and shape of the blocks can be suitably set; however, it is preferable to set each block to have the same shape and an equal area. In Example 1, the block divider 11 equally divides an image into 16 equal blocks in the horizontal direction and 16 equal blocks in the vertical direction (16×16 blocks), and generates 256 blocks. That is, when an image 21 illustrated in FIG. 2 is inputted, as illustrated in FIG. 3, the image 21 is divided into 256 divisions, each one of which has the same shape and size as each other, and 256 blocks 22 are generated.

The region setter 12 uses each of the blocks 22 generated by the block divider 11, and the image (image data), classifies the image by color temperature, and sets a plurality of regions (color temperature regions). In Example 1, the region setter 12 sets regions (color temperature regions) in the image (image data) as follows.

For example, when a target image (not illustrated) is an image of a scene including a white portion (white and its approximate color) photographed with natural daylight of a color temperature of 4000K (Kelvin), as illustrated in FIG. 5, the region setter 12 plots values of G/R and G/B (WB evaluation values) based on image signals (R, G, B) of the photographed white portion on a two-dimensional chromatic coordinate (color space) where a horizontal axis (X axis) is taken as G/R and a vertical axis (Y axis) is taken as G/B. As the values of G/R and G/B (WB evaluation values), as described later, values calculated by the evaluation value obtainer 13 can be used. On the chromatic coordinate (color space), a plurality of oval frames along a black body locus are arranged. Those frames are white detection frames corresponding to white detection ranges of light sources, respectively. On a chromatic coordinate (color space) where a horizontal axis (X axis) is taken as G/R and a vertical axis (Y axis) is taken as G/B, those white detection frames indicate a black body radiation locus in a case where color temperatures of light sources (evening sun, shade, incandescent light, and the like) change as reference gains. In Example 1, those white detection frames are oval in shape; however, if they are configured as described above, they can be rectangular in shape, and are not limited to the configuration of Example 1.

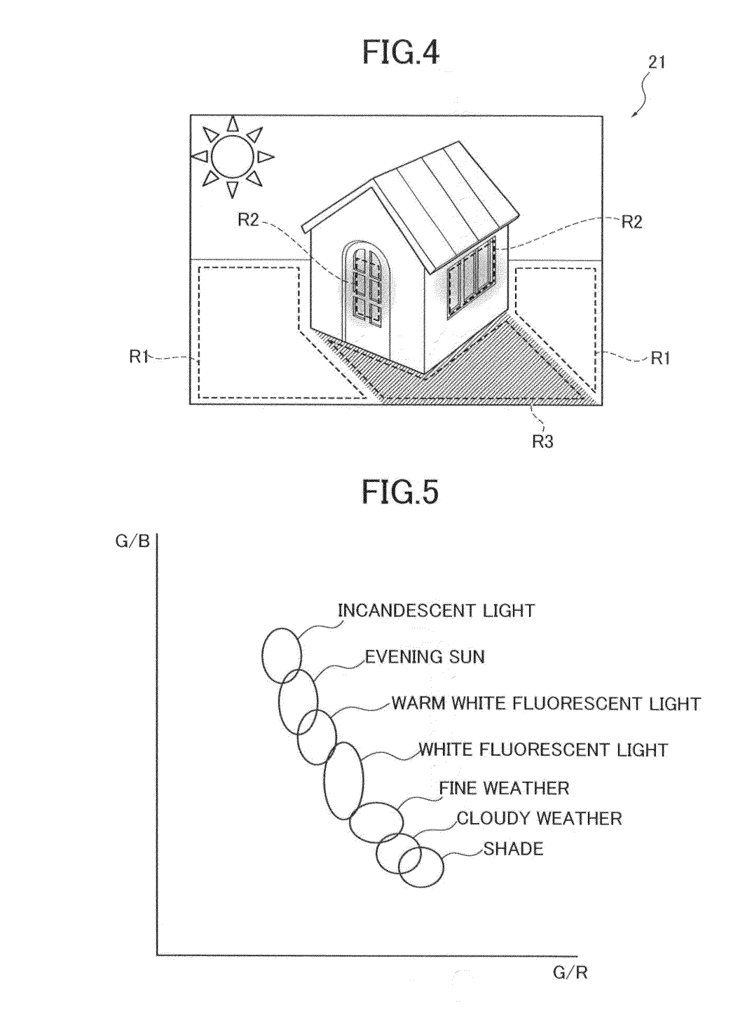

In an example illustrated in FIG. 5, a white detection frame of incandescent light detects white of a color temperature of 2300K-2600K, a white detection frame of white fluorescent light detects white of a color temperature of 3500K-4300K, a white detection frame of shade detects white of a color temperature of 7000K-9000K. Therefore, when the image signal of the above white portion (color temperature of 4000K) is plotted on the above chromatic coordinate (color space), it is plotted in the vicinity of the white detection frame of the white fluorescent light (3500K-4300K) on the black body locus of white. Thus, when a photographic subject is a white object, a color temperature of each of the blocks 22 is obtained by determining color temperature at the plotted position on the black body locus of white. And then, by classifying the blocks 22 by obtained color temperature, it is possible to set a plurality of regions (color temperature regions) in the image (on-screen image). In Example 1, when the image 21 illustrated in FIG. 2 is inputted, as illustrated in FIG. 4, based on the color temperature of each of the blocks 22 generated by the block divider 11, the region setter 12 sets a region (color temperature region) of a white ground illuminated by an evening sun (hereinafter, also referred to as a first color temperature region R1), a region of a door and a window of a house from which light of a white fluorescent light leaks (hereinafter, also referred to as a second color temperature region R2), and a region of a white ground on which a shadow of the house is formed (hereinafter, also referred to as a third color temperature region R3). In an example illustrated in FIG. 4, in order to simplify an explanation, setting of regions (color temperature regions) of a portion indicating the sky, and a portion of the house other than the door and the window of the house is omitted. In a case where it is not possible to set a plurality of regions (color temperature regions) by the region setter 12 (for example, a case where obtained color temperature is one, and the like), the image-processing device 10 performs known WB control.

If the region setter 12 is one that classifies an image (on-screen image) by color temperature and sets a plurality of regions (color temperature regions) to the image based on color temperatures in the image (on-screen image), other methods can be used, and it is not limited to the above method. And the region setter 12 uses each of the blocks 22 generated by the block divider 11; however, if the region setter 12 is one that classifies the image (on-screen image) by color temperature and sets a plurality of regions (color temperature regions) to the image, and it is not limited to the above method.

Based on the image (image data of the image), the evaluation value obtainer 13 obtains an evaluation value of each of the blocks 22 (see FIG. 2) generated by the block divider 11. The evaluation value obtainer 13 calculates each of accumulated values (R accumulated value, G accumulated value, B accumulated value) of RGB components (R component, G component, B component) of each of the blocks 22 by accumulating RGB values (R value, G value, B value) of each of the blocks 22 of the image (image data of the image), respectively, and dividing each of the RGB values by the number of each of RGB pixels (the number of R pixel, the number of G pixel, the number of B pixel) of each of the blocks 22 (average). Then, the evaluation value obtainer 13 calculates WB evaluation values (G/B (ratio of G accumulated values to B accumulated values), G/R (ratio of G accumulated values to R accumulated values)) of each of the blocks 22 from each of the accumulated values. Therefore, the evaluation value obtainer 13 functions as a white balance evaluation value obtainer that obtains a white balance evaluation value of each of the blocks 22 generated by the block divider 11.

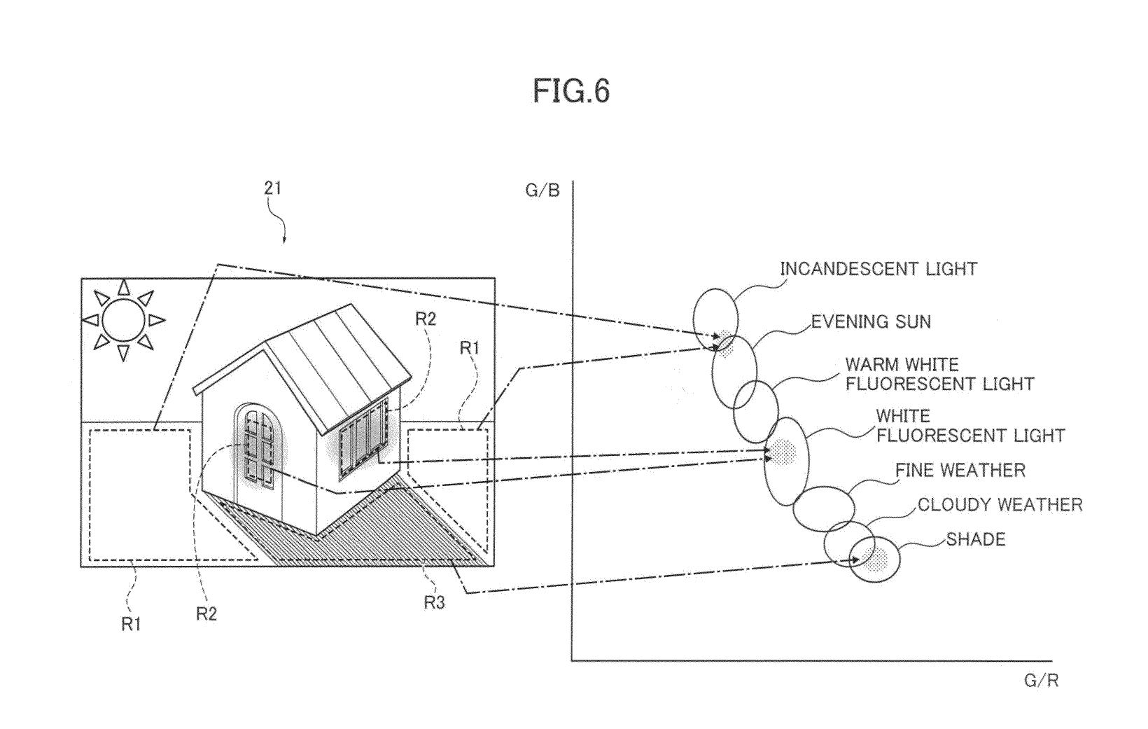

The white detection frame setter 14 sets white detection frames (see FIG. 5) suitable for the plurality of regions (color temperature regions) set by the region setter 12. The white detection frame setter 14 plots a point indicating each of the blocks 22 (its WB evaluation value) on the chromatic coordinate (color space) illustrated in FIG. 5 based on the WB evaluation values (G/B, G/R) of each of the blocks 22 calculated by the evaluation value obtainer 13. Then, a point indicating a block 22 equivalent to a white portion (photographic subject) in an image (on-screen image) in the blocks 22 exists in any one of white detection frames of color temperature (evening sun, shade, incandescent light, and the like) (see FIG. 6). In other words, on the chromatic coordinate (color space), since each of the blocks 22 is indicated by the WB evaluation value, a WB evaluation value of a block 22 that exists in any one of the white detection frames of the color temperature (evening sun, shade, incandescent light, and the like) is a white evaluation value that indicates a white portion. Therefore, the white detection frame setter 14 detects a white detection frame in which any one of points (block 22) is plotted within in each of the white detection frames, assigns the detected white frame to a region (color temperature region) to which the point (block 22) belongs, and stores them. In other words, the white detection frame setter 14 detects a white detection frame in which any one of a plurality of points (blocks 22 indicated by WB evaluation values) that belongs to a target region exists within, per region (color temperature region) set by the region setter 12, assigns the detected white detection frame to the region, and stores them. Here, the plurality of regions (color temperature regions) are set by being classified (divided) by color temperature by the region setter 12, and therefore, regarding a point (block 22) that exists within in any one of the white detection frames, a distribution range in which points that belong to an equal region is extremely narrow. Therefore, a white detection frame alone, or two or three white detection frames next to each other is/are assigned to one region (color temperature region).

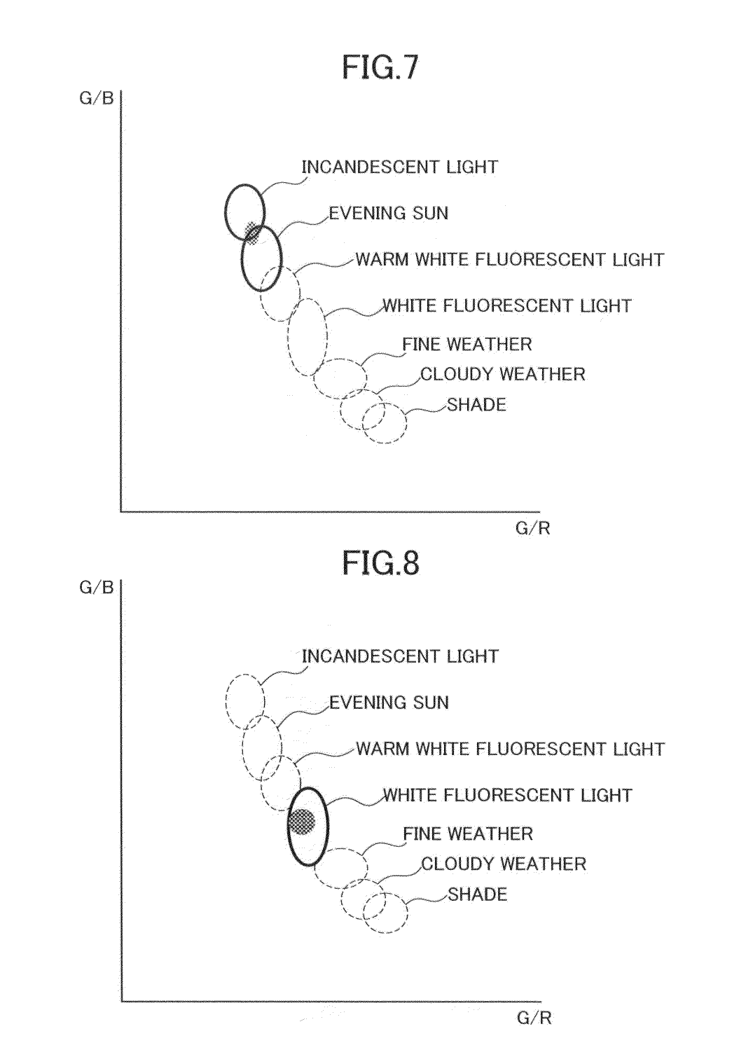

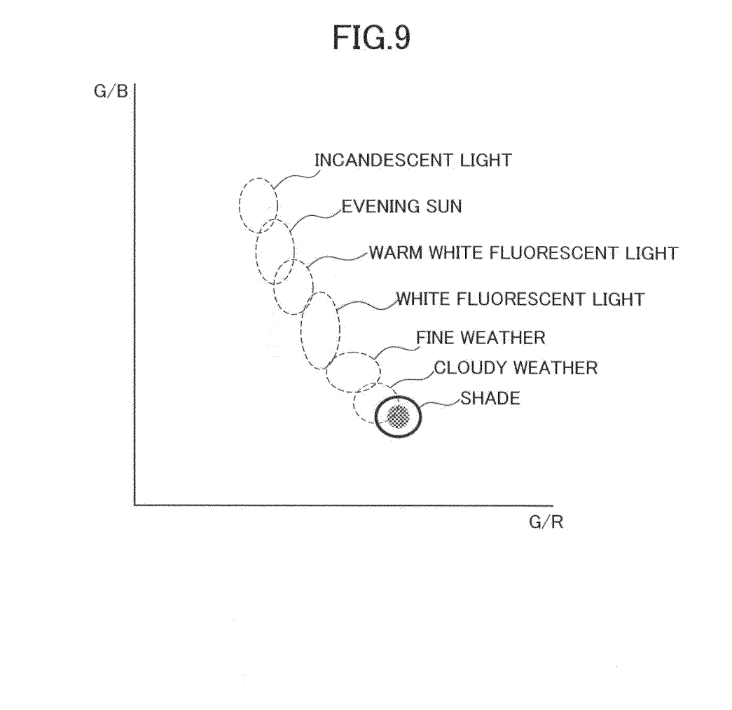

In Example 1, when the image 21 illustrated in FIG. 2 is inputted, as illustrated in FIG. 6, points (blocks 22) that exist within in any one of the white detection frames of points of the first color temperature region R1 of the white ground illuminated by the evening sun are distributed in the vicinity of a border between the white detection frame of the incandescent light and the white detection frame of the evening sun, and within the white detection frame of the incandescent light, or the white detection frame of the evening sun. Therefore, in the white detection frame setter 14, the white detection frame of the incandescent light and the white detection frame of the evening sun (see FIG. 7) are assigned to the first color temperature region R1 (see FIG. 4), and stored. Additionally, points (blocks 22) that exists within in any one of the white detection frames of points of the second color temperature region R2 of the door and the window of the house from which the white fluorescent light leaks are distributed in the white detection frame of the white fluorescent light. Therefore, in the white detection frame setter 14, the white detection frame of the white fluorescent light (see FIG. 8) is assigned to the second color temperature region R2 (see FIG. 4), and stored. Furthermore, points (blocks 22) that exists within in any one of the white detection frames of points of the third color temperature region R3 of the white ground on which the shadow of the house is formed are distributed in the white detection frame of the shade. Therefore, in the white detection frame setter 14, the white detection frame of the shade (see FIG. 9) is assigned to the third color temperature region R3 (see FIG. 4), and stored.

With respect to an input image (image data), the WB gain calculator 15 calculates a WB gain (white balance gain) by use of only a white detection frame assigned to a target region of regions (color temperature regions) and stored by the white detection frame setter 14. From any one target region (color temperature region) in an input image (image data), the WB gain calculator 15 extracts a block 22 that exists only in a white detection frame assigned to the region (target region) by the white detection frame setter 14. That is, by use of a WB evaluation value of each of the blocks 22 included in the region (target region), the WB gain calculator 15 extracts a block 22 that exists only in the white detection frame assigned to the region (target region) by the white detection frame setter 14. In a case of thus extracting a block 22 that exists only in a white detection frame assigned to any one target region, in place of extracting a block 22 from the region (target region) in the input image (image data), the WB gain calculator 15 extracts a block 22 from an entire input image (image data). In other words, by use of WB evaluation values of all of the blocks of the image (image data), the above block 22 can be extracted. The WB gain calculator 15 obtains a WB gain per block 22 from a WB evaluation value of each extracted block 22.

The WB gain calculator 15 calculates an average brightness value (average Y value) of each block 22 from each accumulated value (R accumulated value, G accumulated value, B accumulated value) of the RGB components (R component, G component, B component) in each extracted block 22, and sets a weighting coefficient in each block 22 (its WB gain) based on the average brightness value (average Y value). The weighting coefficient is set so as to add more weight to a WB gain of the block 22 where an average brightness value (average Y value) is high. By multiplying a WB gain of each extracted block 22 by a weighting coefficient of a corresponding block 22, the WB gain calculator 15 calculates a WB gain in each extracted block 22 after weighting. Then, the WB gain calculator 15 calculates an average value of WB gains in each extracted block 22 after weighting. The WB gain calculator 15 calculates a WB gain obtained by use of the white detection frame assigned to the target region (color temperature region) and stored, that is, a WB gain suitable for the target region. In a case of calculating a WB gain, it is not always necessary to perform weighting based on the average brightness value (average Y value), and weighting can be appropriately performed based on other information. Additionally, in place of extraction in units of blocks 22, an extraction can be performed in units of blocks 22 subdivided.

When the image 21 illustrated in FIG. 2 is inputted, in a case where the first color temperature region R1 is a target region, by use of the white detection frame of the incandescent light, and the white detection frame of the evening sun (see FIG. 7) assigned to the first color temperature region R1 by the white detection frame setter 14, from the first color temperature region R1 of the image 21, the WB gain calculator 15 extracts a block 22 that exists in the white detection frame of the incandescent light, and a block 22 that exists in the white detection block of the evening sun, and appropriately performs weighting based on RGB data of each extracted block 22, and calculates a WB gain. Likewise, in a case where the second color temperature region R2 is a target region, from the second color temperature region R2 of the image 21, the WB gain calculator 15 extracts a block 22 that exists in the white detection frame of the white fluorescent light (see FIG. 8), and appropriately performs weighting based on RGB data of each extracted block 22, and calculates a WB gain. In addition, in a case where the third color temperature region R3 is a target region, from the third color temperature region R3 of the image 21, the WB gain calculator 15 extracts a block 22 that exists in the white detection frame of the shade (see FIG. 9), and appropriately performs weighting based on RGB data of each extracted block 22, and calculates a WB gain.

The WB control image generator 16 performs WB control by use of the WB gain calculated by the WB gain calculator 15. By multiplying an entire input image (each pixel data of image data) by the WB gain calculated by the WB gain calculator 15, the WB control image generator 16 generates an image (image data) in which the WB control is performed and WB (white balance) is adjusted. Therefore, The WB gain calculator 15, and the WB control image generator 16 function as a white balance controller that generates an image in which white balance is adjusted based on color temperature of a target region of the regions (color temperature regions) set by the region setter 12, that is, generates a white-balance(WB)-adjusted image.

When the image 21 illustrated in FIG. 2 is inputted, in a case where the first color temperature region R1 is a target region, the WB control image generator 16 multiplies an entire image (its image data) by the WB gain calculated by use of the white detection frames of the incandescent light and the evening sun (see FIG. 7) by the WB gain calculator 15, and generates a WB-adjusted image (its image data). Likewise, in a case where the second color temperature region R2 is a target region, the WB control image generator 16 multiplies an entire image (its image data) by the WB gain calculated by use of the white detection frame of the white fluorescent light (see FIG. 8) by the WB gain calculator 15, and generates a WB-adjusted image (its image data). Additionally, in a case where the third color temperature region R3 is a target region, the WB control image generator 16 multiplies an entire image (its image data) by the WB gain calculated by use of the white detection frame of the shade (see FIG. 9) by the WB gain calculator 15, and generates a WB-adjusted image (its image data).

Under control of the image-processing device 10, the memory 17 appropriately stores contents generated and set by each part relating to the above-described WB control process (block divider 11, region setter 12, evaluation value obtainer 13, white detection frame setter 14, WB gain calculator 15, WB control image generator 16), and appropriately takes out them.

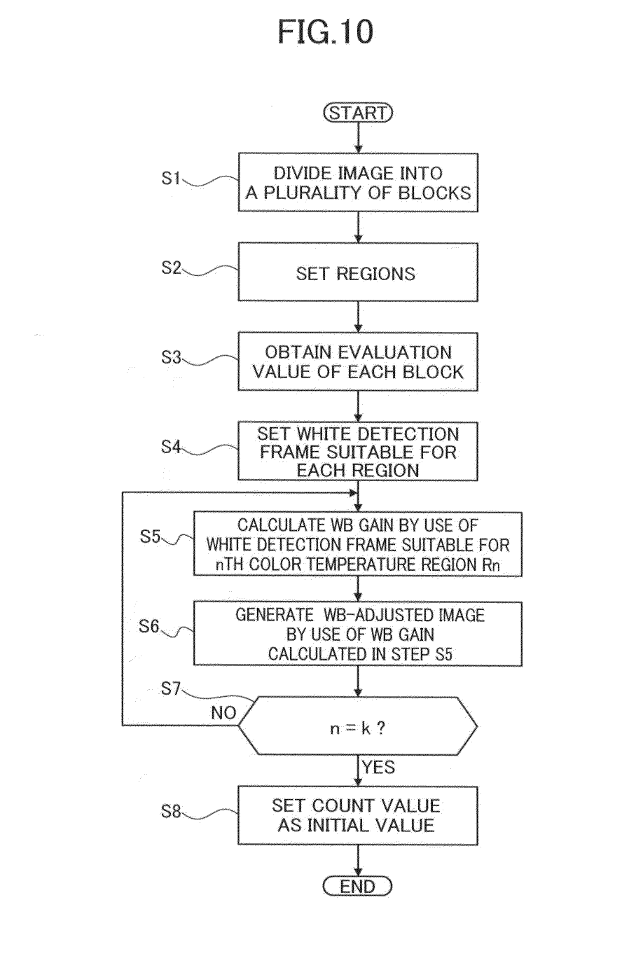

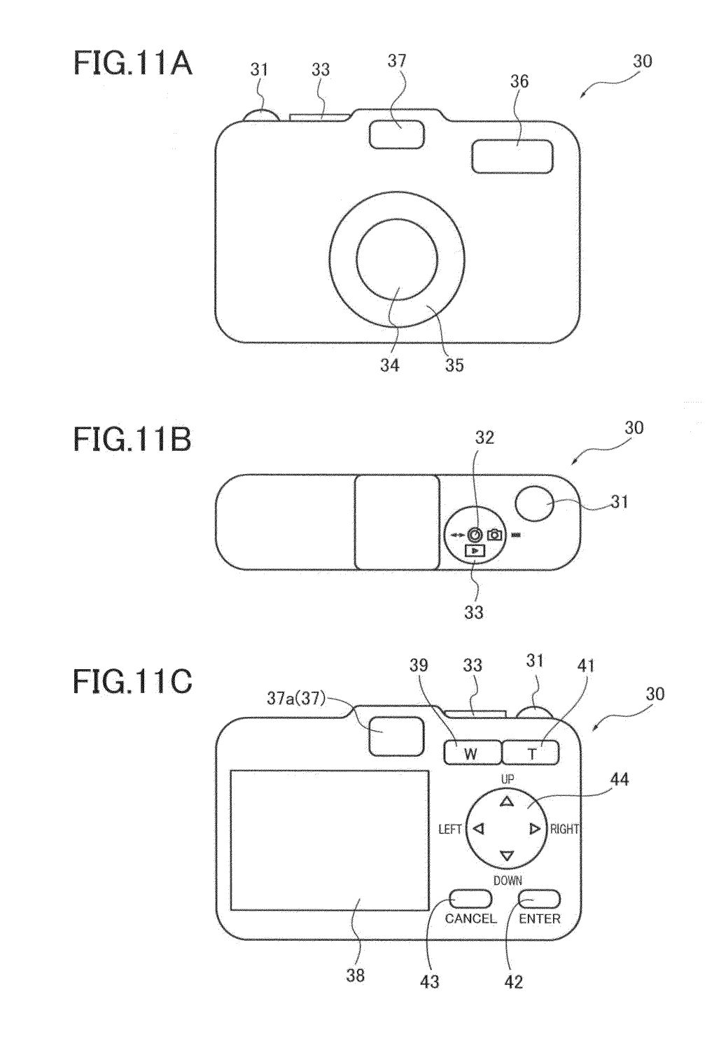

Next, each step of the flow diagram in FIG. 10 as an example of a control process in the image-processing device 10 in a case of performing WB control according to an embodiment of the present invention will be explained. When an image (image data) is inputted to the image-processing device 10, the flow diagram in FIG. 10 begins. Additionally, as described later, when a WB control process begins, a count value n (n=positive integers) that counts a number of a region (color temperature region) of an nth color temperature region Rn is 1.

In the step S1, an input image (image data) is divided into a plurality of blocks, and the process goes on to the step S2. In the step S1, in the block divider 11, the input image (image data) is divided into the set number of divisions (in Example 1, equally divided into 256 divisions), the set number of the blocks (in Example 1, 256 blocks 22 (see FIG. 3)) are generated, and information of each of the blocks is stored in the memory 17.

In the step S2, following the division of the image into the plurality of blocks in the step S1, regions (color temperature regions) are set, and the process goes on to the step S3. In the step S2, in the region setter 12, by use of each of the blocks (blocks 22) generated in the step S1 (block divider 11), a plurality of regions (color temperature regions) in the image (image data) is set, a different count value n is individually assigned, and information of each color temperature region (nth color temperature region Rn) is stored in the memory 17. That is, when an image 21 illustrated in FIG. 2 is inputted, and three regions (color temperature regions) are set as illustrated in FIG. 4, a count value n of the first color temperature region R1 as n=1, a count value n of the second color temperature region R2 as n=2, and a count value n of the third color temperature region R3 as n=3 are stored in the memory 17. In addition, in the step S2, the number k of the set regions (color temperature regions) is stored in the memory 17. That is, when the first color temperature region R1, the second color temperature region R2, and the third color temperature region R3 are set as described above (see FIG. 4), the number k (k=positive integers) of the regions (color temperature regions) is stored as k=3 in the memory 17.

In the step S3, following the setting of the regions (color temperature regions) in the step S2, evaluation values of each of the blocks generated in the step S1 are obtained, and the process goes on to the step S4. In the step S3, in the evaluation value obtainer 13, WB evaluation values (G/B, G/R) of each of the blocks (blocks 22) generated in the step S1 are calculated, assigned to each of the blocks, and stored in the memory 17.

In the step S4, following the obtaining of the evaluation values of each of the blocks in the step S3, a white detection frame suitable for each of the regions (color temperature regions) set in the step S2 is set, and the process goes on to the step S5. In the step S4, in the white detection frame setter 14, a white detection frame suitable for each of the regions (color temperature regions) generated in the step S2 (region setter 12) and stored in the memory 17 is detected, and each detected white frame is assigned to each of the regions, and stored in the memory 17.

In the step S5, following the setting of the white detection frame suitable for each of the regions (color temperature regions) in the step S4, or determination of n≠k in the step S7 described later, a WB gain is calculated by use of the white detection frame suitable for the nth color temperature region Rn set in the step S4, and the process goes on to the step S6. In the step S5, in the WB gain calculator 15, by use of a WB evaluation value of each of the blocks 22 in the nth color temperature region of the input image (image data), a block 22 that exists only in the white detection frame assigned to the nth color temperature region Rn and stored in the memory 17 by the step S4 (the white detection setter 14) is extracted, a WB gain is calculated by appropriately performing weighting based on RGB data of each extracted block 22, and the WB gain is stored in the memory 17.

In the step S6, following the calculation of the WB gain by use of the white detection frame suitable for the nth color temperature frame calculated in the step S5, a WB-adjusted image (image data) is generated by use of the WB gain calculated in the step S5, and the process goes on to the step S7. In the step S6, in the WB control image generator 16, a WB-adjusted image is generated by multiplying an entire input image (each pixel data of image data) by the WB gain calculated in the step S5 (WB gain calculator 15) (by performing WB control), and the WB-adjusted image (image data) is stored in the memory 17. Therefore, in the steps S5 and S6, a target region is the nth color temperature region Rn.

In the step S7, following the generation of the WB-adjusted image (image data) in the step S6 by use of the WB gain calculated in the step S5, whether n=k or not is determined, in a case of YES (n=k), the process goes on to the step S8, and in a case of NO (n≠k), a count value n that counts a number of the nth color temperature region Rn is rewritten by an expression of n=n+1 (rewritten as a value of n+1), stored in the memory 17, and the process returns to the step S5. In the step S7, the count value n (the number of times of performing the step S5 and the step S6) is the number k of the set regions (color temperature regions). That is, it is determined whether the number of the WB-adjusted images (image data) generated in the step S6 (WB control image generator 16) is equal to the number of the regions generated in the step S2 (region setter 12) or not.

In the step S8, following the determination of n=k in the step S7, the count value n is taken as an initial value (1), and the flow diagram ends. Then, the image-processing device 10 appropriately outputs the number k of WB-adjusted images (image data) stored in the memory 17.

Thus, in the image-processing device 10, when the image 21 illustrated in FIG. 2 is inputted, the process goes on from step S1 to the step S2, a first color temperature region R1, a second color temperature region R2, and a third color temperature region R3 are set (see FIG. 4), and the number k of the regions as k 3 is stored. Then, the process goes on to the step S3, the step S4, and the step S5. When a count value n is 1, the first color temperature region R1 in the image (image data) is a target region, a WB gain is calculated by use of a white detection frame of incandescent light and a white detection frame of an evening sun (see FIG. 7) assigned to the first color temperature region R1. And then, the process goes on to the step S6. The entire input image (each pixel data of the image data) is multiplied by the WB gain calculated by use of the white detection frames of the incandescent light and the evening sun (WB control is performed), a WB-adjusted image (image data) is generated, and stored in the memory 17.

Then, the process goes on to the step S7. When the count value n is 1, and is not equal to the number k of the set regions (color temperature regions) (k=3), the count value n is taken as 2, and the process returns to the step S5. And when the count value n is 2, a second color temperature region R2 in the image (image data) is a target region, a WB gain is calculated by use of a white detection frame of white fluorescent light (see FIG. 8) assigned to the second color temperature region R2, and the process goes on to the step S6. The entire input image (each pixel data of the image data) is multiplied by the WB gain calculated by use of the white detection frame of the white fluorescent light (WB control is performed), a WB-adjusted image (image data) is generated, and stored in the memory 17.

Then, the process goes on to the step S7. When the count value n is 2, and is not equal to the number k of the set regions (color temperature regions) (k=3), the count value n is taken as 3, and the process returns to the step S5. And when the count value n is 3, a third color temperature region R3 in the image (image data) is a target region, a WB gain is calculated by use of a white detection frame of shade (see FIG. 9) assigned to the third color temperature region R3, the process goes on to the step S6. The entire input image (each pixel data of the image data) is multiplied by the WB gain calculated by use of the white detection frame of the shade (WB control is performed), a WB-adjusted image (image data) is generated, and stored in the memory 17.

Then, the process goes on to the step S7. When the count value n is 3, and is equal to the number k of the set regions (color temperature regions) (k=3), the process goes on to the step S8, the count value n is taken as an initial value (1), and the WB control process ends. At this time, each of the generated WB-adjusted images (image data) stored in the memory 17 is appropriately outputted. Therefore, in the image-processing device 10, when the image 21 illustrated in FIG. 2 is inputted, and three regions (color temperature regions) (see FIG. 4) are set in the image, a WB-adjusted image (image data) based on color temperatures of the white detection frames of the incandescent light and evening sun, that is, based on color temperature of the first color temperature region R1, a WB-adjusted image (image data) based on color temperature of the white detection frame of the white fluorescent light, that is, based on color temperature of the second color temperature region R2, and a WB-adjusted image (image data) based on color temperature of the white detection frame of the shade, that is, based on color temperature of the third color temperature region R3 are approximately outputted. That is, in the image-processing device 10, when a plurality of color temperature regions exist in the input image (image data), WB-adjusted images, each one of which is an image in which WB is appropriately adjusted based on any one of the plurality of the color temperatures, are generated as many as the number of the plurality of the color temperatures that exist, that is, the number equal to the number of the regions set by the region setter 12. In Example 1, the flow diagram in FIG. 10 is performed; however, likewise to the above-described operation, it is only necessary to generate WB-adjusted images (image data), each of which is an image in which WB is appropriately adjusted based on color temperature of any one of the regions (color temperature regions) of the input image (image data), as many as the number equal to the number of the regions set by the region setter 12, and it is not limited to the flow diagram in FIG. 10.

In the image-processing device 10 according to Example 1 of the present invention, when a plurality of color temperature regions exist in an input image, WB-adjusted images, each of which is an image in which WB is adjusted based on color temperature of any one of the regions (color temperature regions), are generated as many as the number of the regions set by the region setter 12, that is, the number equal to the number of the regions that exists. And therefore, even in a case where regions different in color temperature exist in an on-screen image, it is possible to make any one of generated images to be appropriately adjusted with respect to any color temperature region.

Additionally, in the image-processing device 10, a plurality of images (image data) to be generated are WB-adjusted images based on any one of color temperatures of a plurality of regions (color temperature regions) that exist in an input image, respectively. And therefore, even in a case where any photographic subject in an image is a target, it is possible to make any one of generated images to be an image in which WB is appropriately adjusted based on color temperature of the region in which the photographic subject exits.

In addition, in the image-processing device 10, a plurality of images (image data) to be generated are WB-adjusted images based on any one of color temperatures of a plurality of regions (color temperature regions) that exist in an input image, respectively. And therefore, for example, even in a case where two photographic subjects such as background and a person are targets, it is possible to generate an image in which WB is appropriately adjusted based on color temperature of the region in which the background exists, and an image in which WB is appropriately adjusted based on color temperature of the region in which the person exists.

In the image-processing device 10, by use of only white detection frames that include WB evaluation values of a target region (color temperature region), a WB gain for adjusting WB based on color temperature of the target region is calculated. And therefore, it is possible to adjust WB based on the color temperature of the target region specifically, compared with a regular WB control that uses all white detection frames. Thus, determining a block taken as a WB evaluation value of an unintended color temperature to be white by a white detection frame different in color temperature from that of a previously-set region can be prevented. Therefore, it is possible to generate an image in which WB is more appropriately adjusted based on the target region (color temperature region).

In the image-processing device 10, it is possible to make any one of generated images to be appropriately adjusted with respect to any region (color temperature region). And therefore, it is possible for a user to select an image that matches to an imagined image of the user from a plurality of generated images (image data), and obtain an image with intended color.

Therefore, in the image-processing device 10 according to Example 1 of the present invention, in a case where regions different in color temperature exist in an image, it is possible to obtain an image appropriately adjusted based on color temperature of each of the regions.

In Example 1, in an input image (image data), an image (image data) in which WB is adjusted based on a color temperature of any one of a plurality of regions (color temperature regions) set by the region setter 12 is generated with respect to all of the regions set by the region setter 12, respectively (WB-adjusted images are generated as many as the number equal to the number of the set regions). However, an image (WB-adjusted image) can be generated with respect to at least two regions of the regions (color temperature regions) set by the region setter 12, respectively (at least two WB-adjusted images are generated), and it is not limited to Example 1. At this time, selection of the regions from the set regions (color temperature regions) can be performed in order from a region large in area, in order from a region high in brightness, or the like, for example.

### Example 2

Next, an image-processing device 102 according to Example 2 of the present invention, and an imaging apparatus 30 including the image-processing device 102 according to Example 2 of the present invention will be explained with reference to FIGS. 11A to 16. Example 2 is an example where the image-processing device 102 is included in the imaging apparatus 30, and therefore, Example 2 is an example where a structure for performing a WB control process is different. The image-processing device 102 basically has the same structure as that of the above-described image-processing device 10 of Example 1, and therefore, portions equal to those of the image-processing device 10 are denoted by the same reference signs, and detailed explanations are omitted.

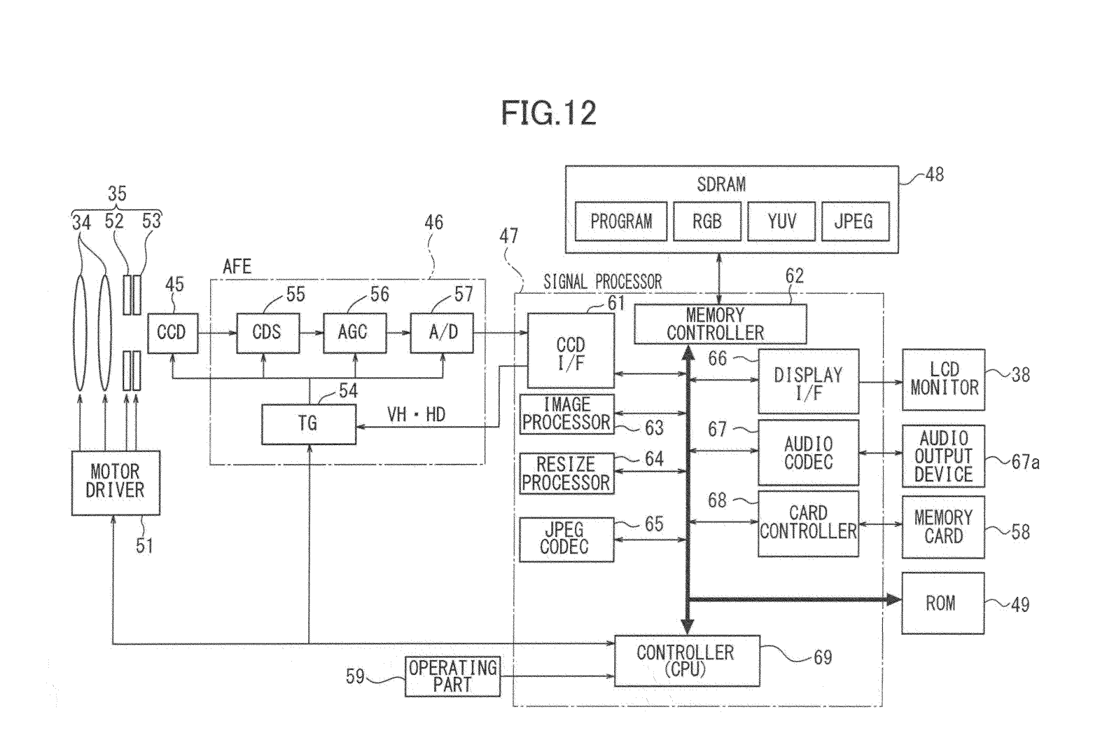

Firstly, the structure of the imaging apparatus 30 including the image-processing device 102 will be explained with reference to FIGS. 11A to 12. Each of FIGS. 11A to 11C is an explanatory diagram that explains the structure of the imaging apparatus 30. FIGS. 11A to 11C illustrate a front view, a top view, and a rear view, respectively. FIG. 12 is a block diagram that illustrates a system configuration of the imaging apparatus 30.

In the imaging apparatus 30, as illustrated in FIGS. 11A to 11C, on a top side, a shutter button 31, a power button 32, and a photographing/reproducing switch dial 33 are provided. The shutter button 31 is pressed downward in the vertical direction in order to photograph a photographic subject (perform a photographing operation). The power button 32 performs an operation (start operation) to start the imaging apparatus 30 to be in an operating state, and performs an operation (stop operation) to stop the imaging apparatus to be in a non-operating state. On the front side of the imaging apparatus 30, a lens barrel unit 35 having a photographing lens system 34, a flash 36, and an optical viewfinder 37 are provided.

On the rear side of the imaging apparatus 30, a liquid crystal display (LCD) monitor 38, an eyepiece lens 37a of the optical viewfinder 37, a wide-angle zoom (W) switch 39, a telephoto zoom (T) switch 41, a confirmation button (ENTER button) 42, a cancel button (CANCEL button) 43, and a direction instruction button 44 are provided. The LCD monitor 38 includes a liquid crystal display, and under control of a later-described controller 69 (see FIG. 12), the LCD monitor 38 is a display that displays an image based on obtained (imaged) image data, and image data recorded in a recording medium. Additionally, on the inside of the side of the imaging apparatus 30, a memory card slot (not illustrated) is provided, and the memory card slot accommodates a memory card 58 (see FIG. 12) for storing photographed image data.

As illustrated in FIG. 12, the imaging apparatus 30 includes the lens barrel unit 35, a CCD (Charge-Coupled Device) 45, an analog front end 46 (hereinafter, referred to as AFE 46), a signal processor 47, an SDRAM (Synchronous Dynamic Range Access Memory) 48, a ROM (Read-Only Memory) 49, and a motor driver 51.

The lens barrel unit 35 includes the photographing lens system 34 that includes a zoom lens, a focus lens, and the like, an aperture unit 52, and a mechanical shutter unit 53. Drive units (not illustrated) of the photographing lens system 34, the aperture unit 52, and the mechanical shutter unit 53 are each driven by the motor driver 51. The motor driver 51 is driven and controlled by a drive signal from the later-described controller 69 of the signal processor 47. The SDRAM 48 temporarily stores data. In the ROM 49, a control program, and the like are stored.

The CCD 45 is a solid-state image sensor, and an image of a photographic subject incident through the photographing lens system 34 of the lens barrel unit 35 is formed on a light-receiving surface of the CCD 45. Although illustration is omitted, RGB primary color filters as color separation filters are arranged on a plurality of pixels constituting the CCD 45, and the CCD 45 outputs an electric signal (analog RGB image signal) corresponding to the three RGB primary colors from each pixel. In Example 2, the CCD 45 is used; however, if an image of a photographic subject imaged on a light-receiving surface is converted to an electric signal (analog RGB image signal) and outputted, a solid-state image sensor such as a CMOS (Complementary Metal-Oxide Semiconductor) image sensor can be used, and it is not limited to Example 2.

The AFE 46 processes the electric signal (analog RGB image signal) outputted from the CCD 45 to a digital signal. The AFE 46 has a TG (Timing Signal Generator) 54, a CDS (Correlated Double Sampler) 55, an AGC (Analog Gain Controller) 56, and an A/D (Analog/Digital) convertor 57. The TG 54 drives the CCD 45. The CDS 55 samples the electric signal (analog RGB image signal) outputted from the CCD 45. The AGC 56 adjusts a gain of the signal sampled in the CDS 55. The A/D convertor 57 converts the gain-adjusted signal in the AGC 56 to a digital signal (hereinafter, referred to as RAW-RGB data).

The signal processor 47 processes the digital signal outputted from the AFE 46. The signal processor 47 has a CCD interface 61 (hereinafter, also referred to as CCD I/F 61), a memory controller 62, an image processor 63, a resize processor 64, a JPEG codec 65, a display interface 66 (hereinafter, also referred to as display I/F 66), an audio codec 67, a card controller 68, and the controller (CPU) 69.

The CCD I/F 61 outputs a picture horizontal synchronizing signal (HD) and a picture vertical synchronizing signal (VD) to the TG 54 of the AFE 46, and in synchronization with those synchronizing signals, loads the RAW-RGB data outputted from the A/D convertor 57 of the AFE 46. The CCD I/F 61 writes (stores) the loaded RAW-RGB data in the SDRAM 48 via the memory controller 62. The memory controller 62 controls the SDRAM 48.

The image processor 63 converts the RAW-RGB data temporarily stored in the SDRAM 48 to image data in the YUV system (YUV data) based on image-processing parameters set in the controller 69, and writes (stores) it in the SDRAM 48. The YUV system is a system in which color is expressed by information of brightness data (Y), and color differences (difference (U) between brightness data and blue (B) component data, and difference (V) between brightness data and red (R) component data).

The resize processor 64 reads out the YUV data temporarily stored in the SDRAM 48, and appropriately performs conversion to the size necessary to be stored, conversion to the size of a thumbnail image, conversion to the size suitable to be displayed, and the like.

The JPEG codec 65 outputs JPEG-coded data to which the YUV data written in the SDRAM 48 is compressed, when storing on the memory card 58, or the like. Additionally, the JPEG codec 65 decompresses the JPEG-coded data read out from the memory card 58, or the like to YUV data, and outputs it, when reproducing from the memory card 58, or the like.

The display I/F 66 controls output of data for display temporarily stored in the SDRAM 48 to the LCD monitor 38, an external monitor (not illustrated), or the like. Therefore, it is possible to display an image as data for display, or the like on the LCD monitor 38, the external monitor, or the like.

The Audio codec 67 performs digital-analog conversion on audio data, appropriately amplifies it, and outputs audio to an audio output device 67a. Additionally, the audio codec 67 performs analog-digital conversion on audio inputted from an audio input device (not illustrated), and performs compression and coding processes.

From an instruction from the controller 69, the card controller 68 reads out the data on the memory card 58 to the SDRAM 48, and writes the data in the SDRAM 48 to the memory card 58. In the SDRAM 48, the RAW-RGB data loaded in the CCD I/F 61 is stored, the YUV data (image data in the YUV system) converted by the image processor 63 is stored, and additionally, image data compressed in JPEG format by the JPEG codec 65, or the like is stored.

When starting operation, the controller (CPU) 69 loads a program and control data stored in the ROM 49 to the SDRAM 48, and performs an entire system control of the imaging apparatus 30, and the like based on the program. Additionally, based on an instruction by an input operation to an operating part 59, an instruction by an external operation of a remote controller (not illustrated), or the like, or an instruction by a communication operation by communication from an external terminal device such as a personal computer, or the like, the controller 69 performs the entire system control of the imaging apparatus 30, and the like. The entire system control of the imaging apparatus 30, and the like include an imaging operation control, setting of image-processing parameters in the image-processing device 102, a memory control, a display control, and the like.

The operating part 59 is operated to perform an operation instruction of the imaging apparatus 30 by a user, and is included in the imaging apparatus 30. Based on an operation by the user, a predetermined operation instruction signal is inputted to the controller 69. The operating part 59 has the shutter button 31, the power button 32, the photographing/reproducing switch dial 33, the wide-angle zoom switch 39, the telephoto zoom switch 41, the confirmation button 42, the cancel button 43, the direction instruction button 44, and the like (see FIGS. 11A to 11C) provided on an external surface of the imaging apparatus 30.

The imaging apparatus 30 performs a live-view operation process, and while performing the live-view operation process, the imaging apparatus 30 is allowed to perform a still image photographing operation. In a live-view operation, an obtained image (photographing image) is concurrently displayed on the LCD monitor 38 (in real time). When in a still image photographing mode, the imaging apparatus 30 performs the still image photographing operation while performing the following live-view operation process.

Firstly, in the imaging apparatus 30, when a start operation that starts the imaging apparatus 30 to be in an operating state is performed by the power button 32, and the photographing/reproducing switch dial 33 is set to a photographing mode, the controller 69 outputs a control signal to the motor driver 51, and moves the lens barrel unit 35 to a photographable position. At this time, the controller 69 also starts the LCD monitor 38, the CCD 45, the AFE 46, the signal processor 47, the SDRAM 48, the ROM 49, and the like together.

An image of a photographic subject at which the photographing lens system 34 of the lens barrel unit 35 aims is incident through the photographing lens system 34, and formed on a light-receiving surface of each pixel of the CCD 45. Then, the CCD 45 outputs an electric signal (analog RGB image signal) in accordance with the image of the photographic subject, the electric signal is inputted to the A/D convertor 57 via the CDS 55 and the AGC 56, and converted to 12-bit RAW-RGB data by the A/D convertor 57.

The controller 69 loads the RAW-RGB data to the CCD I/F 61 of the signal processor 47, and stores it in the SDRAM 48 via the memory controller 62. And after reading out the RAW-RGB data from the SDRAM 48 and converting to YUV data (YUV signal) that is in a displayable format by the image processor 63, the controller 69 stores the YUV data in the SDRAM 48 via the memory controller 62.

The controller 69 reads out the YUV data from the SDRAM 48 via the memory controller 62, and sends it to the LCD monitor 38 via the display I/F 66, and therefore, a photographing image is displayed on the LCD monitor 38. Thus, the imaging apparatus 30 performs the live-view operation that displays the photographing image on the LCD monitor 38. While performing the live-view operation, one frame is read out in 1/30 second by a process of thinning the number of pixels by the CCD I/F 61. While performing the live-view operation, the photographing image is only displayed on the LCD monitor 38 that functions as a display (electronic viewfinder), and it is in a state where the shutter button 31 is not pressed (including half-press). Accordingly, while performing the live-view operation, it is possible for a user to confirm the photographing image by the display of the photographing image on the LCD monitor 38. It is possible to display the photographing image on an external monitor such as an external TV, or the like via a video cable by outputting the photographing image as a TV video signal from the display I/F 66.

When performing the live-view operation, the controller 69 calculates an AF (autofocus) evaluation value, an exposure (AE (auto exposure)) evaluation value, a WB (AWB (auto white balance)) evaluation value from the RAW-RGB data loaded by the CCD I/F 61 of the signal processor 47.

The AF evaluation value is calculated by an output integrated value of a high-frequency wave component extraction filter, or an integrated value of a brightness difference between peripheral pixels. When in focus, an edge portion of a photographic subject is clear, and therefore, the level of a high frequency component is highest. By use of this, when performing a later-described AF operation (in-focus position detection operation), an AF evaluation value at each position of a focus lens in the photographing lens system 34 is obtained, and a position where the AF evaluation value is largest is a detected in-focus position.

The exposure evaluation value is calculated from each integrated value of RGB values in the RAW-RGB data. For example, likewise to the WB evaluation value, an on-screen image corresponding to a light-receiving surface of entire pixels of the CCD 45 is equally divided into 256 blocks 22 (see FIG. 3), accumulated values of RGB values of each of the blocks 22 is calculated, based on the accumulated values of the RGB values, a brightness value (Y value) is calculated, and the exposure evaluation value is obtained from the brightness value. Based on the exposure evaluation value, the controller 69 determines an appropriate exposure amount from brightness distribution of each of the blocks 22. And, based on the determined exposure amount, the controller 69 sets exposure conditions (the number of releases of an electronic shutter of the CCD 45, an aperture value of the aperture unit 52, and the like), drives the aperture unit 52 and the mechanical shutter unit 53 (each of their drive units (not illustrated)) so as to meet the set exposure conditions by the motor driver 51, and performs the auto exposure (AE) operation. Therefore, in the imaging apparatus 30, the motor drive 51, the aperture unit 52, and the mechanical shutter unit 53 function as an exposure controller that sets exposure conditions so as to become the determined exposure amount based on the exposure evaluation value.

The WB evaluation value is the same as that in Example 1. The controller 69 determines color of a photographic subject and color of a light source based on the WB evaluation value, and obtains an AWB control value (WB gain) based on color temperature of the light source. When converting to YUV data by the image processor 63, the controller 69 performs an AWB process (regular WB control) that adjusts WB by use of the obtained AWB control value (WB gain). The controller 69 consecutively performs the AWB process and the above-described auto exposure (AE) process, while performing the live-view operation process.

When the shutter button 31 is half-pressed, while performing the live-view operation, the controller 69 performs an AF operation control as the focus position detection operation. In the AF operation control, by a drive instruction from the controller 69 to the motor driver 51, the focus lens of the photographing lens system 34 moves, and, for example, an AF operation of a contrast evaluation type, which is a so-called hill-climbing AF, is performed. At this time, in a case where an AF (in-focus) target range is an entire region from infinity to a closest range, the focus lens of the photographing lens system 34 moves to each position from the closest range to infinity, or from infinity to the closest range, and the controller 69 reads out the AF evaluation values at each position of the focus lens calculated in the CCD I/F. The position where the AF evaluation value at each position of the focus lens is largest is taken as an in-focus position, and the controller 69 moves the focus lens to the in-focus position, and focusing is thus performed.

Additionally, when the shutter button 31 is fully-pressed, the controller 69 performs a still image storing process so as to start a still image photographing operation. In the still image storing process, the mechanical shutter unit 53 is closed by a drive instruction from the controller 69 to the motor driver 51, and outputs an analog RGB image signal for a still image from the CCD 45. Likewise when the live-view operation process is performed, the analog RGB image signal is converted to RAW-RGB data by the A/D convertor 57 of the AFE 46. Then, the controller 69 loads the RAW-RGB data to the CCD I/F 61 of the signal processor 47, converts the RAW-RGB data to YUV data (YUV signal) in the image processor 63, and stores the YUV data in the SDRAM 48 via the memory controller 62. The controller 69 reads out the YUV data from the SDRAM 48, the YUV data is changed to the size corresponding to the number of recording pixels by the resize processor 64, and compressed to image data in JPEG format, or the like in the JPEG codec 65. After writing the image data compressed to the image data in JPEG format, or the like back to the SDRAM 48, the controller 69 reads it out from the SDRAM 48 via the memory controller 62, and stores it to the memory card 58 via the card controller 68. This series of the operations is a regular still image recording process.

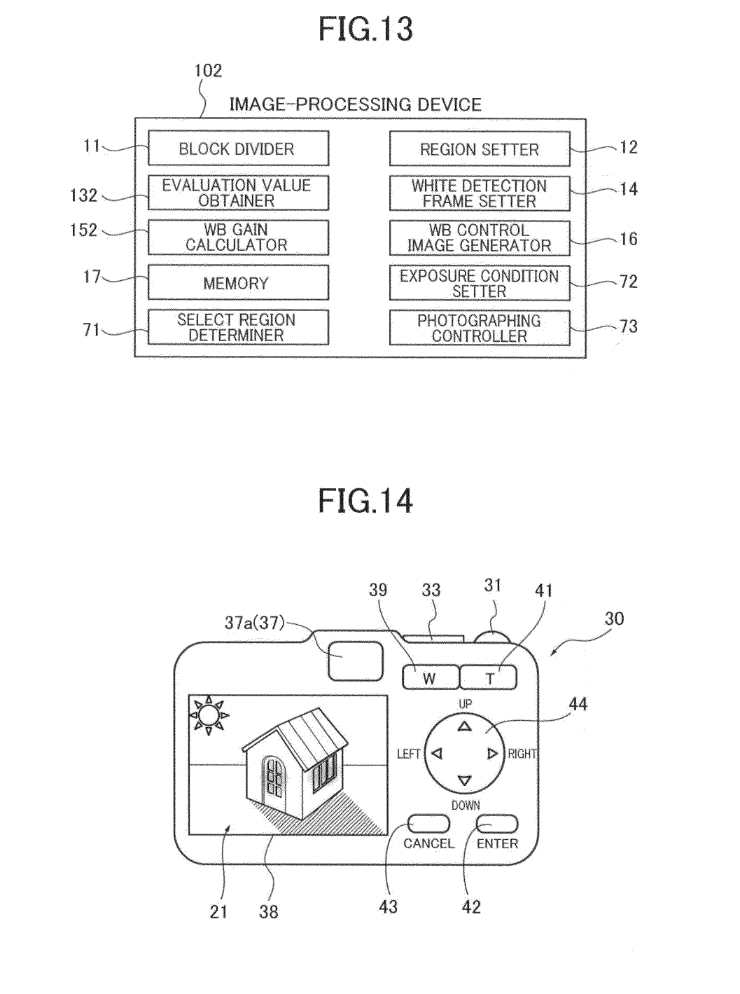

In the imaging apparatus 30, although clear illustration is omitted, the image-processing device 102 is included in the controller 69. The image-processing device 102 is included in the imaging apparatus 30 (controller 69 of the imaging apparatus 30), and therefore, basically, as described above, an image (image data) obtained by the imaging apparatus 30 is inputted. As illustrated in FIG. 13, the image-processing device 102 includes a block divider 11, a region setter 12, an evaluation value obtainer 132, a white detection frame setter 14, a WB gain calculator 152, a WB control image generator 16, and a memory 17, which basically have the same structures as those of the image-processing device 10 in Example 1. In addition to those, the image-processing device 102 includes a select region determiner 71, an exposure condition setter 72, and a photographing controller 73. The block divider 11, the region setter 12, the white detection frame setter 14, the WB control image generator 16, and the memory 17 are the same as those in Example 1.

The evaluation value obtainer 132 calculates WB evaluation values (G/B, G/R) of each of blocks 22 from RGB values (R value, G value, B value) of each of the blocks 22, which is the same as the evaluation value obtainer 13 in Example 1. By the evaluation value obtainer 132, in addition to calculation of the WB evaluation value, an exposure evaluation value is calculated from each integrated value of the RGB values in RAW-RGB data. The exposure evaluation value is obtained such that accumulated values of the RGB values of each of the blocks 22 are calculated, a brightness value (Y value) is calculated based on the accumulated values of the RGB values, and the exposure evaluation value is obtained from the brightness value. In Example 2, as the exposure evaluation value, an accumulated value of a brightness value and an average value of a brightness value are used. Therefore, the evaluation value obtainer 132 functions as a white balance evaluation value obtainer that obtains a white balance evaluation value of each of the blocks 22 generated in the block divider 11, and functions as an exposure evaluation value obtainer that obtains an exposure evaluation value of each of the blocks 22.

The WB gain calculator 152 is basically the same as the WB gain calculator 15 in Example 1; however, in Example 2, from an entire input image (image data), that is, from all the blocks 22 of the image (image data), the WB gain calculator 152 extracts a block 22 that exists only in a white detection frame assigned to any one target region. Likewise to the WB gain calculator 15 in Example 1, from any one target region (color temperature region) in an input image (image data), the WB gain calculator 152 can extract a block 22 that exists only in a white detection frame assigned to the region (target region) in the white detection frame setter 14. And likewise to the WB gain calculator 15, by calculating an average value of WB gains after weighting each extracted block 22, the WB gain calculator 152 calculates a WB gain by use of a white detection frame that is assigned to the target region (color temperature region) and stored. In a case of calculating a WB gain, it is not necessary to perform weighting by the average brightness value (average Y value), and weighting can be appropriately performed based on other information. Additionally, in place of extracting each of the blocks 22 as a unit, each of the blocks 22 can be subdivided and extracted as a unit.

The select region determiner 71 is capable of selecting a desired region from the regions (color temperature regions) set by the region setter 12. In Example 2, as illustrated in FIG. 14, on a photographing image displayed on the LCD monitor 38, an arbitrary region or position on the photographing image displayed on the LCD monitor 38 by the live-view operation process is specified, and the desired region is selected by the select region determiner 71. The select region determiner 71 is capable of specifying the position by reflecting an operation of the operating part 59 on the photographing image. As such a method of reflection on the photographing image, although a clear illustration is omitted, there is a method in which the target region in the regions set by the region setter 12 are highlighted, and when an operation is performed on the operating part 59, in place of the target region, regions other than the target region is highlighted (switching of display of regions is performed). Although a clear illustration is omitted, highlighting a region means, in order to define the region, changing color or brightness of the region only, and surrounding the region with a line, a dotted line, or the like. Additionally, although clear illustrations are omitted, as other methods of reflection on the photographing image, there are a method of selecting the region from entire regions that are distinctively displayed, a method of specifying an arbitrary position on the photographing image by displaying an indication symbol such as an arrow, or the like on the photographing image and moving the indication symbol, and a method of specifying an arbitrary block 22 from the blocks 22 displayed on the photographing image. In a case where an arbitrary position, or an arbitrary block 22 is specified on the photographing image, it is determined that a region (color temperature region) including the specified position or the specified block 22 is selected.

The exposure condition setter 72 sets exposure conditions to the regions (color temperature regions) set by the region setter 12. The exposure condition setter 72 determines an appropriate exposure amount of the region based on an exposure evaluation value of each of the blocks 22 included in the target region of exposure evaluation values of the blocks 22 calculated by the evaluation value obtainer 132. And the exposure condition setter 72 sets exposure conditions (the number of releases of an electronic shutter of the CCD 45, an aperture value of the aperture unit 52, and the like) based on the determined exposure amount.

The photographing controller 73 performs exposure control in accordance with the exposure conditions set by the exposure condition setter 72, and performs image-obtaining control (photographing). The photographing controller 73 performs the image-obtaining control (photographing) such that after the aperture unit 52 and the mechanical shutter unit 53 (each drive unit (not illustrated) of them) are driven by the motor driver 51, and exposure control under the exposure conditions set by the exposure condition setter 72 is performed, the mechanical shutter unit 53 is closed by a drive instruction to the motor driver 51, and via the AFE 46, RAW-RGB data is obtained. Thus, an analog RGB image signal for a still image is outputted from the CCD 45, converted to RAW-RGB data by the A/D convertor 57 of the AFE 46, and the RAW-RGB data (image data) is inputted to the signal processor 47. Accordingly, an image (image data) under the exposure condition set by the exposure condition setter 72 is obtained.

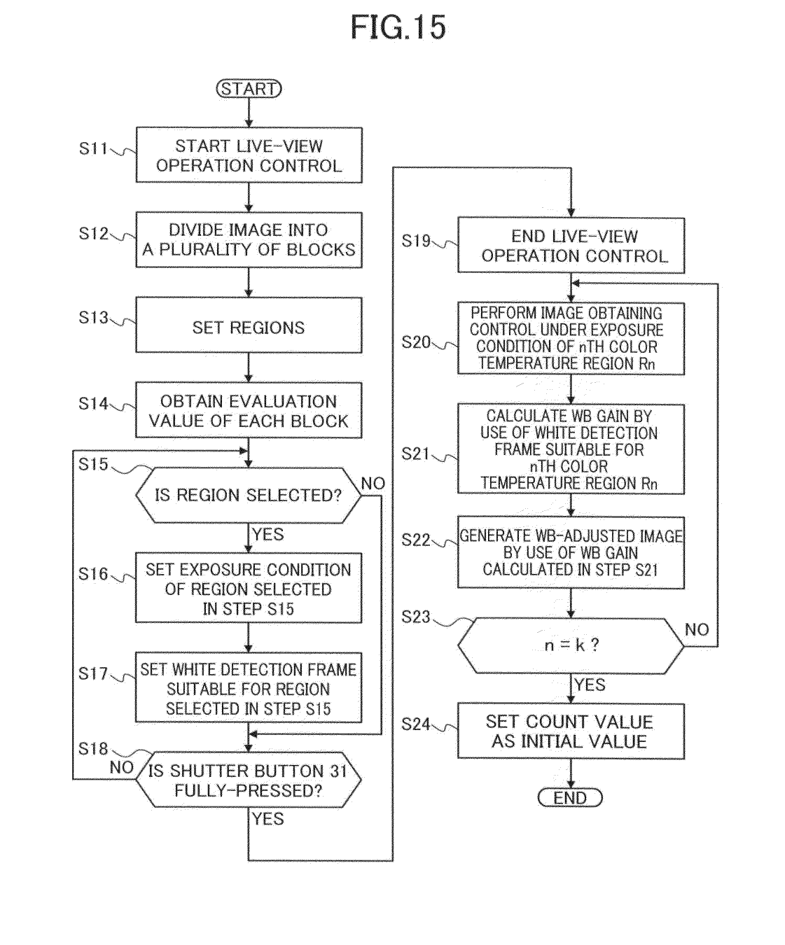

Next, each step of the flow diagram of FIG. 15 as an example of a control process in the image-processing device 102 (controller 69) in a case of performing WB control according to an embodiment of the present invention will be explained. The flow diagram of FIG. 15 begins when the imaging apparatus 30 is in an operating state by the power button 32 and setting to perform the WB control (this flow diagram) according to an embodiment of the present invention is performed. The setting is allowed by an operation of the operating part 59, and in a case where the setting is not performed, a regular still image recording process control including a regular WB control is performed. As described later, when a WB control process begins, a count value n (n=positive integers) that counts a number of a region (color temperature region) of an nth color temperature region Rn is 1.

In the step S11, a live-view operation control begins, and the process goes on to the step S12. In the step S11, the live-view operation control begins, and a photographing image is displayed in real time.

In the step S12, following the beginning of the live-view operation control, an image (image data) obtained by a live-view operation is divided into a plurality of blocks, and the process goes on to the step S13. Except for an input image being the image (image data) obtained by the live-view operation, the step S12 is the same as the step S1 in the flow diagram of FIG. 10.

In the step S13, following the division of the plurality of the blocks in the step S12, regions (color temperature regions) are set, and the process goes on to the step S14. In the step S13, in the region setter 12, by use of each of the blocks 22 generated in the step S12 (block divider 11), a plurality of regions (color temperature regions) in the image (image data) obtained by the live-view operation are set, and information of each region is stored in the memory 17. In the step S13, unlike the step S2 in the flow diagram of FIG. 10, a different count value n is not individually assigned to the set information of each region, and the number k (k=positive integers) of the set regions are not stored in the memory 17. Therefore, in Example 2, the image (image data) obtained by the live-view operation is a first image.

In the step S14, following the setting of the regions (color temperature regions) in the step S13, an evaluation value of each of the blocks generated in the step S12 is obtained, and the process goes on to the step S15. In the step S14, in the evaluation value obtainer 132, WB evaluation values (G/B, G/R) of each of the blocks (blocks 22) generated in the step S12 (block divider 11) and stored in the memory 17 are calculated, assigned to each of the blocks, and stored in the memory 17. Additionally, in the step S14, in the evaluation value obtainer 132, an exposure evaluation value of each of the blocks (blocks 22) generated in the step S12 (block divider 11) and stored in the memory 17 is calculated, assigned to each of the blocks, and stored in the memory 17.

In the step S15, following the obtaining of the evaluation values of each of the blocks in the step S14, or determination that the shutter button 31 is not fully-pressed in the later-described step S18, whether a region (color temperature region) is selected or not is determined. In a case of YES, the process goes on to the step S16, and in a case of NO, the process goes on to the step S18. In the step S15, in the select region determiner 71, on the photographing image displayed on the LCD monitor 38, whether any one of the regions (color temperature regions) set in the step S13 (region setter 12) is selected or not is determined. And in a case where any one of the regions is selected, a count value n is assigned to the selected region, and information of the selected region (nth color temperature region Rn) is stored in the memory 17. That is, in a case where a count value n is 1, the selected region is stored as a first color temperature region R1 in the memory 17, and in a case where a count value n is 2, the selected region is stored as a second temperature region R2 in the memory 17.

In the step S16, following the determination that the region (color temperature region) is selected in the step S15, an exposure condition of the region (color temperature region) selected in the step S15 is set, and the process goes on to the step S17. In the step S16, in the exposure condition setter 72, based on an exposure evaluation value of each of the blocks 22 of the region (nth color temperature region) stored in the memory 17 assigned to the count value n, an exposure condition of the region is set, assigned to the region (nth color temperature region), and stored in the memory 17.

In the step S17, following the setting of the exposure condition of the region (color temperature region) selected in the step S16, a white detection frame suitable to the region (color temperature region) selected in the step S15 is set, and the process goes on to the step S18. In the step S17, in the white detection frame setter 14, based on the WB evaluation values of each of the blocks 22 of the region (nth color temperature region Rn) stored in the memory 17 assigned to the count value n, a white detection frame suitable to the region is detected, assigned to the region (nth color temperature region), and stored in the memory 17. Then, in the step S17, a count value n that counts a number of an nth color temperature region Rn is rewritten by an expression of n=n+1 (rewritten as a value to which 1 is added), stored in the memory 17, and the process goes on to the step S18.

In the step S18, following the setting of the white detection frame suitable to the region (color temperature region) selected in the step S17, or determination that no region (color temperature region) is selected in the step S15, whether the shutter button 31 is fully-pressed or not is determined. In a case of YES, the process goes on to the step S19, and in a case of NO, the process returns to the step S15. In the step S18, by determining whether the shutter button 31 is fully-pressed or not, whether there is an intention of beginning a photographing operation of a photographic subject or not is determined, and in a case where there is the intention of beginning the photographing operation, it is determined that selection of the region (color temperature region) is finished.

In the step S19, following the determination that the shutter button 31 is fully-pressed in the step S18, the live-view operation control is finished, and the process goes on to the step S20. In the step S19, in addition to finishing the live-view operation control, the number k of the selected regions (color temperature regions) is stored in the memory 17. In this example, since the number k of the regions (color temperature regions) selected in the step S15 becomes a count value n−1 by going through the step S17, the number k (k=n−1) is stored in the memory 17. And then, in the step S19, the count value n that counts the number of the nth color temperature region Rn is set to an initial value (1), stored in the memory 17, and the process goes on to the step S20.

In the step S20, following the end of the live-view operation control in the step S19, or the determination of n≠k in the later-described step S23, an image-obtaining control (photographing) under the exposure condition of the nth color temperature region Rn is performed, and the process goes on to the step S21. In the step S20, in the photographing controller 73, after exposure control under the exposure condition, which was set, assigned to the nth color temperature region Rn, and stored in the memory 17 in the step S16 (exposure condition setter 72), is performed, the mechanical shutter unit 53 is closed by a drive instruction to the motor driver 51, and the image-obtaining control (photographing) that obtains RAW-RGB data via the AFE 46 is performed. Therefore, in the step S20, an image (image data) under the exposure condition of the nth color temperature region Rn is obtained.

In the step S21, following the image-obtaining control under the exposure condition of the nth color temperature region Rn in the step S20, by use of the white detection frame suitable to the nth color temperature region Rn, a WB gain is calculated, and the process goes on to the step S22. In the step S21, in the WB gain calculator 152, blocks are generated as many as the number of the blocks set by the block divider 11 (in this example, 256 blocks 22 (see FIG. 3)) from the image (image data) obtained in the step S20 (photographing controller 73), WB evaluation values of each of the blocks 22 are obtained by the evaluation value obtainer 132, by use of the WB evaluation values, a block that exists only in the white detection frame assigned to the nth color temperature region Rn and stored in the memory 17 in the step S17 is extracted, based on RGB data of the extracted block, weighting is performed, a WB gain is calculated, and the WB gain is stored in the memory 17.

In the step S22, following the calculation of the WB gain by use of the white detection frame suitable to the nth color temperature region Rn in the step S21, an image (image data) in which WB is adjusted is generated by use of the WB gain calculated in the step S21, and the process goes on to the step S23. In the step S22, in the WB control image generator 16, by multiplying an entire image (each pixel data of image data) obtained in the step S20 (photographing controller 73) by the WB gain calculated in the step S21 (WB gain calculator 152) (by performing the WB control), a WB-adjusted image (image data) is generated, and the image (image data) is stored in the memory 17. Therefore, in Example 2, an image (image data) obtained under the exposure condition of the nth color temperature region Rn in the step S20 is a second image. From the steps S20 to S22, the nth color temperature region Rn selected in the step S15 (select region determiner 71) is a target region.

In the step S23, following the generation of the WB-adjusted image (image data) in the step S22, whether n=k or not is determined. In a case of YES (n−k), the process goes on to the step S24, and in a case of NO (n≠k), the count value n that counts the number of the nth color temperature region Rn is rewritten by the expression of n=n+1 (rewritten to a value to which 1 is added), stored in the memory 17, and the process returns to step S20. In the step S23, whether the number k of the regions (color temperature regions) set by the count value n (the number of times of performing the steps S20 to S22), that is, the number of the WB-adjusted images (image data) generated in the step S22 (WB control image generator 16) is equal to the number of the regions selected in the step S15 (select region determiner 71) or not is determined.

In the step S24, following the determination of n=k in the step S23, the count value n is taken as the initial value (1), and the flow diagram is finished. Then, the image-processing device 102 appropriately outputs the number k of the WB-adjusted images (image data) stored in the memory S17.

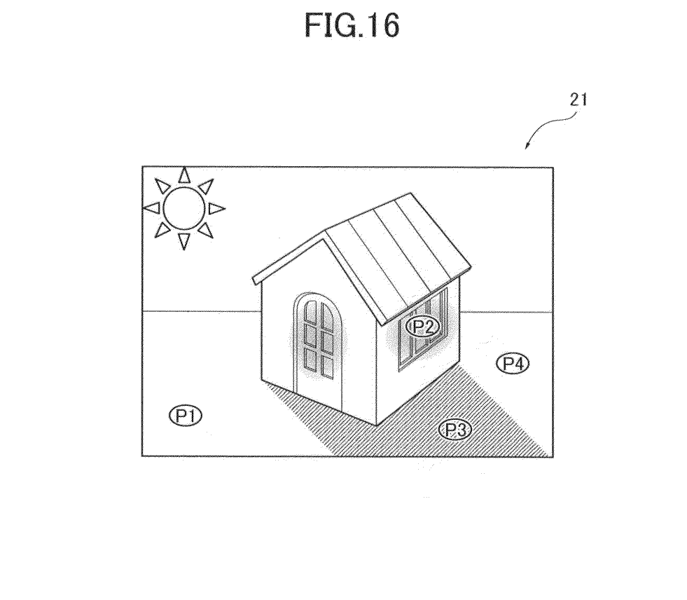

Thus, in the image-processing device 102, in a case where scenery of an image 21 illustrated in FIG. 2 is a photographic subject, the process goes on to the step S11, and a photographing image is displayed on the LCD monitor 38 by a live-view operation (see FIG. 14). Then, the process goes on to the steps S12, S13, S14, and S15, and when a position P1 (see FIG. 16) is selected on the LCD monitor 38, and a count value n is 1, a region (color temperature region) including the position P1 is set as a first color temperature region R1 (see FIG. 4). Then, the process goes on to the steps S16, and S17, and an exposure condition of the first color temperature region R1, and a white detection frame of incandescent light and a white detection frame of an evening sun (see FIG. 7) are assigned to the first color temperature region R1, and stored. Then, in a case where the shutter button 31 is not fully-pressed, the process goes on to the step S15 from the step S18. And when a position P2 is selected on the LCD monitor 38, and a count value n is 2, a region (color temperature region) including the position P2 is set as a second color temperature region R2 (see FIG. 4). Then, the process goes on to the steps S16, and S17, and an exposure condition of the second color temperature region R2, and a white detection frame of white fluorescent light (see FIG. 8) are assigned to the second color temperature region R2, and stored. Then, in a case where the shutter button is not fully-pressed, the process goes on to the step S15 from the step S18. And when a position P3 is selected on the LCD monitor 38, and a count value is 3, a region (color temperature region) including the position P3 is set as a third color temperature region R3 (see FIG. 4). Then, the process goes on to the steps S16 and S17, an exposure condition of the third color temperature region R3, and a white detection frame of shade (see FIG. 9) are assigned to the third color temperature region R3, and stored. Here, in the step S15, in a case where no region (color temperature region) is selected on the LCD monitor 38, the same operations described above are repeated, except that assignment of the exposure conditions and the white detection frames and addition of the count value n in the steps S16 and S17 are not performed.

And then, when the shutter button is fully-pressed, the process goes on to the steps S19 and S20. When the count value n is 1, an image (image data) is obtained under the exposure condition of the first color temperature region R1. Then, the process goes on to the step S21, and with respect to the image (image data) obtained under the exposure condition of the first color temperature region R1, by use of the white detection frame of the incandescent light and the white detection frame of the evening sun (see FIG. 7) assigned to the first color temperature region R1, a WB gain is calculated. Then, the process goes on to the step S22, and by multiplying an entire image (each pixel data of image data) obtained under the exposure condition of the first color temperature region R1 by the WB gain calculated by use of the white detection frames of the incandescent light and the evening sun from the image (image data) (by performing the WB control), a WB-adjusted image (image data) is generated and stored in the memory 17.

Then, the process goes on to the step S23, and when the count value n is 1, and is not equal to the number k (k=3) of the selected regions (color temperature regions), the count value n is taken as 2, and the process returns to the step 20. And when the count value n is 2, an image (image data) is obtained under the exposure condition of the second color temperature region R2. Then, the process goes on to the step S21, and with respect to the image (image data) obtained under the exposure condition of the second color temperature region R2, a WB gain is calculated by use of the white detection frame of the white fluorescent light (see FIG. 8) assigned to the second color temperature region R2. Then, the process goes on to the step S22, by multiplying an entire image (each pixel data of image data) obtained under the exposure condition of the second color temperature region R2 by the WB gain calculated by use of the white detection frame of the white fluorescent light from the image (image data) (by performing the WB control), a WB-adjusted image (image data) is generated, and stored in the memory 17.

Then, the process goes on to the step S23, and when the count value n is 2, and is not equal to the number k (k=3) of the selected regions (color temperature regions), the count value n is taken as 3, and the process returns to the step S20. And when the count value n is 3, an image (image data) under the exposure condition of the third color temperature region R3 is obtained. And then, the process goes on to the step S21, and with respect to the image obtained under the exposure condition of the third color temperature region R3, a WB gain is calculated by use of the white detection frame of the shade (see FIG. 9) assigned to the third color temperature region R3. Then, the process goes on to the step S22, by multiplying an entire image (each pixel data of image data) obtained under the exposure condition of the third color temperature region R3 by the WB gain calculated by use of the white detection frame of the shade from the image (image data) (by performing the WB control), a WB-adjusted image (image data) is generated, and stored in the memory 17.

Then after the process goes on to the step S23, and when the count value n is 3, and equal to the number k (k=3) of the selected regions (color temperature regions), the process goes on to the step S24, and the count value n is taken as an initial value (1), and the WB control process ends. At this time, each of the WB-adjusted images (image data) generated and stored in the memory 17 is appropriately outputted.

Therefore, in the image processor 12 (imaging apparatus 30), in a case where scenery of an image 21 illustrated in FIG. 2 is a photographic subject, and three regions (color temperature regions) in the image 21 are selected (see reference signs P1, P2, P3 in FIG. 16), the WB-adjusted image (image data) based on the white detection frames of the incandescent light and the evening sun, that is, the WB-adjusted image based on color temperature under the exposure condition of the first color temperature region R1 with respect to the image (image data) obtained under the exposure condition of the first color temperature region R1, the WB-adjusted image (image data) based on the white detection frame of the white fluorescent light, that is, the WB-adjusted image based on color temperature under the exposure condition of the second color temperature region R2 with respect to the image (image data) obtained under the exposure condition of the second color temperature region R2, and the WB-adjusted image (image data) based on the white detection frame of the shade, that is, the WB-adjusted image based on color temperature under the exposure condition of the third color temperature region R3 with respect to the image (image data) obtained under the exposure condition of the third color temperature region R3 are generated, and appropriately outputted. That is, in the image-processing device 102 (imaging apparatus 30), in a case where a plurality of regions (color temperature regions) exist in a photographic subject (an image (image 21 (first image) obtained by a live-view operation)) and a plurality of regions are selected from the plurality of the regions (color temperature regions), with respect to an image (image data (second image)) obtained under an exposure condition of any one of the selected regions, a WB-adjusted image based on color temperature of a corresponding region (a region of the image obtained under the exposure condition corresponding to the selected region) is generated as many as the number equal to the number of the selected regions. In Example 2, the flow diagram of FIG. 15 is performed; however, likewise to the above-described operation, with respect to an image (image data) obtained under an exposure condition of any one of the selected region (color temperature region), it is only necessary to generate a WB-adjusted image (image data) based on color temperature of a corresponding region (a region of the image obtained under the exposure condition corresponding to the selected region) as many as the number equal to the number of the selected regions, and it is not limited to the flow diagram of FIG. 15.

Thus, in the image-processing device 102 (imaging apparatus 30) according to Example 2 of the present invention, when a plurality of regions (color temperature regions) of a photographic subject (image of the photographic subject obtained by a live-view operation) are selected, an image (image data) in which WB is adjusted based on color temperature of any one of the selected regions is generated as many as the number equal to the number of the selected regions, respectively. Therefore, even in a case where regions different in color temperature exist in an on-screen image, it is possible to make any one of generated images appropriately adjusted with respect to a region including a selected portion.

Additionally, in the image-processing device 102 (imaging apparatus 30), an image (image data) is obtained under an exposure condition of any one of selected regions (color temperature regions), and with respect to the image (image data), WB is adjusted based on color temperature of the selected region, and therefore, it is possible to generate an image appropriately adjusted with respect to the selected region.

Additionally, in the image-processing device 102 (imaging apparatus 30), regions (color temperature regions) are set based on the image obtained by the live-view operation, and therefore, it is possible to prevent processes after the shutter button 31 is fully-pressed from complication.

In the image-processing device 102 (imaging apparatus 30), regions (color temperature regions) are set based on the image (first image) obtained by the live-view operation, and a desired region is selected from the set regions, and therefore, it is possible to reliably generate an image appropriately adjusted with respect to a target region, and it is possible to prevent processes after the shutter button 31 is fully-pressed from complication.

In the image-processing device 102 (imaging apparatus 30), regions (color temperature regions) are set based on the image (first image) obtained by the live-view operation, and a desired region is selected from the set regions on a photographing image displayed on the LCD monitor 38, and therefore, it is easily and reliably possible to select a target region.

In the image-processing device 102 (imaging apparatus 30), based on the image (first image) obtained by the live-view operation, an exposure condition of a selected region (color temperature region) is set, and therefore, it is possible to obtain an image (image data) under the exposure condition of the selected region soon after the shutter button 31 is fully-pressed.

In the image-processing device 102 (imaging apparatus 30), based on the image (first image) obtained by the live-view operation, a white detection frame in a selected region (color temperature region) is set, and therefore, soon after the shutter button 31 is fully-pressed and an image (image data (second image)) is obtained under an exposure condition of the selected region, it is possible to perform WB control suitable for the selected region.

In the image-processing device 102 (imaging apparatus 30), based on the image (first image) obtained by the live-view operation, a plurality of regions (color temperature regions) are set, a plurality of desired regions are selected from the plurality of the set regions on a photographing image displayed on the LCD monitor 38, and an exposure condition is set for each selected region. And therefore, when the shutter button 31 is fully-pressed, it is possible to consecutively obtain an image (image data (second image)) under the exposure condition of each selected region.

In the image-processing device 102 (imaging apparatus 30), when the shutter button is fully-pressed, it is possible to consecutively obtain the image (image data (second image)) under the exposure condition of each selected region (color temperature region), and therefore, it is possible to extremely reduce an actual time difference when obtaining a plurality of WB-adjusted images generated as many as the number equal to the number of the selected regions.

In the image-processing device 102 (imaging apparatus 30), by use of only a white detection frame including a WB evaluation value of a target region (color temperature region), a WB gain that adjusts WB based on color temperature of the target region is calculated, and therefore, it is possible to adjust WB especially based on the color temperature of the target region. Therefore, it is possible to more appropriately generate a WB-adjusted image suitable for the target region.

In the image-processing device 102 (imaging apparatus 30), desired regions are selected from a plurality of regions set on a photographing image (first image) displayed on the LCD monitor 38 by the live-view operation, and images appropriately adjusted with respect to all of the selected regions are generated, and therefore, it is possible to match each of the generated images with an imagined image, and obtain images with intended color.

In the image-processing device 102 (imaging apparatus 30), an image (image data) under an exposure condition of each selected region (color temperature region) is obtained in the selected order, and an image appropriately adjusted with respect to the selected region is generated. For example, by displaying the generated image on the LCD monitor 38, in the generated order, or every time the image is generated, it is possible to match to a selection operation of a user. Additionally, storing the generated image on the memory card 58 in the generated order makes it possible to match to a selection operation in a case of later confirmation.

Therefore, in the image-processing device 102 (imaging apparatus 30) according to Example 2 of the present invention, it is possible to obtain an image appropriately adjusted based on color temperature of each of the regions.

In the above-described Example 2, in the flow diagram of FIG. 15, after obtaining an image (image data) under an exposure condition of an nth color temperature region Rn in the step S20, the process goes on to the steps S21 and S22. However, without performing the steps S21 and S22, and after repeating the steps of S20 and S23 only by the number k of selected regions (color temperature regions), the WB control can be performed with respect to each obtained image (image data) in the steps S21 and S22, and it is not limited to the above-described Example 2.

In the above-described Example 2, in the flow diagram of FIG. 15, in the step S20, an image (image data (second image)) is obtained under the exposure condition of the nth color temperature region Rn set in the step S16, and the WB control is performed with respect to the image (image data (second image)) in the steps S21 and S22. However, an image (second image) can be obtained under a fixed exposure condition, and the WB control can be performed with respect to the image (second image) in the steps S21 and S22, and it is not limited to the above-described Example 2. In this case, for example, in the step S19, it is only necessary to obtain an image (second image) under a fixed exposure condition, and without performing the step S20, repeat the steps S21, S22, and S23. Additionally, the fixed exposure condition can be set by a known method.

Additionally, in the above-described Example 2, in the select region determiner 71, in order to reflect an operation of the operating part 59 on a photographing image, an arbitrary position on the photographing image is specified by displaying an indication sign such as an arrow, or the like on the photographing image and moving the indication sign, or an arbitrary block 22 is specified by displaying each of the blocks 22 on the photographing image, and therefore, it is determined that the specified position, or a region (color temperature region) including the specified block 22 is selected. In this case, as a position P1 and a position P4 illustrated in FIG. 16, in a case where the same region (a first color temperature region R1 in an example of FIG. 16) includes different specified positions, or different blocks 22, it can be regarded that one region is selected. Therefore, in an example of FIG. 16, regarding selection of the position P1 and the position P4, with respect to an image (image data) under an exposure condition of a first temperature region R1, a WB gain is calculated by use of a white detection frame of incandescent light and a white detection frame of an evening sun (see FIG. 7) assigned to the first color temperature region R1, and one WB-adjusted image (image data) is generated. This makes it possible to prevent images (image data) from being redundantly generated in which WB is adjusted based on the same region. Additionally, apart from the above, in a case where specified different positions, or different blocks 22 are included in the same region (color temperature region), with respect to each selection, it can be regarded that each corresponding region is selected. That is, in an example of FIG. 16, with respect to the selection of the position P1, the first temperature region R1 is set, and with respect to the selection of the position P4, the first temperature region R1 is set, and with respect to each of the selections, a WB-adjusted image can be generated. This makes it possible to match the number of selections with the number of the generated WB-adjusted images (image data), and match to an operation of a user.

In the above-described Example 2, in the flow diagram of FIG. 15, in the step S18, it is determined that the selection of the region (color temperature region) is finished by determining whether the shutter button 31 is fully-pressed or not. However, an operation of ending the selection can be performed in the operating part 59, and it is not limited to the above-described Example 2.

In the above-described Example 2, a WB-adjusted image (image data) is generated from an image obtained by the imaging apparatus 30 (image data (second image)). However, for example, a WB-adjusted image can be generated from an image (image data) stored on the memory card 58 (see FIG. 12), and it is not limited to the above-described Example 2. In this case, it is not possible to obtain an image (image data) under an exposure condition of an nth color temperature region Rn as in the step S20 of the flow diagram of FIG. 15, and therefore, the same process as in the image-processing device 10 in Example 1 is performed. Additionally, in this case, the image (image data) stored on the memory card 58 (see FIG. 12) is a first image on which regions (color temperature regions) are set by the region setter 11, and is a second image as a source of an image in which white balance is adjusted based on color temperature of a target region (color temperature region) by the white balance controller (WB gain calculator 15 and WB control image generator 16). In other words, in this case, the first image and the second image are equal.

In the above-described Example 2, by an operation of the operating part 59, a desired region (color temperature region) is selected by the select region determiner 71 on a photographing image displayed on the LCD monitor 38 while performing a live-view operation. However, since a so-called touchscreen function that functions as an input device by pressing a display on a screen of the LCD monitor 38 can be provided, a desired region can be selected by pressing a photographing image displayed on the LCD monitor 38, and it is not limited to the above-described Example 2.

In each of the above-described examples, the image-processing device 10 and the image-processing device 102 as examples of image processing-devices according to embodiments of the present invention have been explained. However, it is only necessary that the image-processing device be an image-processing device that adjusts white balance of an image, including a region setter that classifies the image by color temperature, and sets a plurality of regions thereto, and a white balance controller that generates a white-balance-adjusted image based on color temperature of a target region of the regions from the image, in which by targeting all of the regions set by the region setter, the white balance controller generates a white-balance-adjusted image as many as the number equal to the number of the regions set by the region setter from the image, or adjusts white balance of the image, or the image-processing device be an image-processing device that adjusts white balance of an image, including a region setter that classifies the image by color temperature and sets a plurality of regions thereto, and a white balance controller that generates an image in which white balance is adjusted based on color temperature of a target region of the regions from the image, in which by targeting at least two regions of the regions set by the region setter, the white balance controller generates at least two white-balance-adjusted images from the image. And it is not limited to each of the examples.

In the above-described Example 2, the imaging apparatus 30 as an example according to an embodiment of the present invention has been explained. It is only necessary that the imaging apparatus be an imaging apparatus having an image-processing device that adjusts white balance, the imaging apparatus obtaining a first image to perform a live-view display, and obtaining a second image in accordance with a photographing operation, including a region setter that classifies the first image by color temperature and sets a plurality of regions thereto, and a white balance controller that generates a white-balance-adjusted image based on the second image, in which the white balance controller targets at least two regions of the regions set by the region setter for white balance control, and based on color temperature of regions in the second image corresponding to the at least two targeted regions, generates at least two white-balance-adjusted images from the second image. And it is not limited to the above-described Example 2.

Additionally, in each of the above-described examples, in the WB gain calculator 15, a WB gain is calculated by use of only a white detection frame detected by the white detection frame setter 14. However, in addition to the white detection frame detected by the white detection frame setter 14, a WB gain can be calculated by use of a white detection frame adjacent thereto. This makes it possible to reduce a possibility that an achromatic region is mistakenly determined to be white and a portion that is not white is whitened.

In the above-described Example 1, regarding an input image (image data), an image (image data) in which WB is adjusted based on color temperature of any one of a plurality of regions (color temperature regions) set by the region setter 12 is generated with respect to all of the regions set by the region setter 12, respectively (WB-adjusted images are generated as many as the number equal to the number of the set regions). However, the select region determiner 71 in Example 2 can be included in the image-processing device 10, desired regions can be selected from the regions set by the region setter 12, and a WB-adjusted image can be generated with respect to all of the selected regions, respectively (WB-adjusted images are generated as many as the number equal to the number of the selected regions). In this case, in the image-processing device 10, the select region determiner 71 in Example 2 can be provided by providing a display (equivalent to the LCD monitor 38 in Example 2) that displays an input image, and an operating part (equivalent to the operating part 59 in Example 2) that enables to select a desired region (color temperature region) on the image.

In the above-described Example 2, the imaging apparatus 30 that includes an image-processing device 10, 102 according to embodiments of the present invention has been described. However, the imaging apparatus can be an imaging apparatus in which a photographing optical system and an image sensor are accommodated in a housing and the housing is detachably attached to a body of the imaging apparatus, and can be an imaging apparatus in which cylindrical portions that hold a photographing optical system are detachably attached. And it is not limited to the above-described Example 2.

In the above-described Example 2, the imaging apparatus 30 that includes an image-processing device 10, 102 according to embodiments of the present invention has been described. However, if an electric device includes the image-processing device 10, 102, the image-processing device 10, 102 according to the embodiments of the present invention can be applied to an electronic device such as a portable information terminal device such as a PDA (Personal Data Assistance), a mobile phone, or the like that includes a camera function. And it is not limited to each of the examples. This is because, although such a portable information terminal device often has a slightly different external appearance, it includes functions and structures substantially exactly the same as those of the imaging apparatus 30.

According to an image-processing device of the present invention, in a case where regions different in color temperature exist in an image, it is possible to obtain an image appropriately adjusted based on color temperature of each of the regions.

Although the present invention has been described in terms of exemplary embodiments, it is not limited thereto. It should be appreciated that variations may be made in the embodiments described by persons skilled in the art without departing from the scope of the present invention as defined by the following claims.

What is claimed is:

1. An image-processing device that adjusts white balance of an image, comprising:
a region setter that classifies the image by color temperature and sets a plurality of regions thereto; and
a white balance controller that generates a white-balance-adjusted image based on color temperature of a target region of the regions from the image, wherein by targeting all of the regions set by the region setter, the white balance controller generates white-balance-adjusted images as many as the number equal to the number of the regions set by the region setter from the image.

2. An image-processing device that adjusts white balance of an image, comprising:
a region setter that classifies the image by color temperature, and sets a plurality of regions thereto; and
a white balance controller that generates a white-balance-adjusted image based on color temperature of a target region of the regions from the image, wherein by targeting at least two regions of the regions set by the region setter, the white balance controller generates at least two white-balance-adjusted images from the image.

3. The image-processing device according to claim 2, further comprising:
a select region determiner that is capable of selecting a desired region from the regions set by the region setter,
wherein by targeting all of the regions set by the select region determiner, the white balance controller generates white-balance-adjusted images as many as the number equal to the number of the regions selected by the select region determiner.

4. The image-processing device according to claim 1, further comprising:
a block divider that divides the image into a plurality of blocks;
a white balance evaluation value obtainer that obtains a white balance evaluation value of each of the blocks; and
a white detection frame setter that sets a suitable white detection frame to each of the regions based on the white balance evaluation value,
wherein by use of a suitable white detection frame set to the target region by the white detection frame setter with respect to the image, the white balance controller generates a white-balance-adjusted image based on color temperature of the target region.

5. An imaging apparatus, which has an image-processing device that adjusts white balance,
the imaging apparatus obtaining a first image to perform a live-view display, and obtaining a second image in accordance with a photographing operation, comprising:
a region setter that classifies the first image by color temperature, and sets a plurality of regions thereto, and
a white balance controller that generates a white-balance-adjusted image based on the second image,
wherein the white balance controller targets at least two regions of the regions set by the region setter for white balance control, and based on color temperature of regions in the second image corresponding to the at least two target regions, generates at least two white-balance-adjusted images from the second image.

6. The imaging apparatus according to claim 5, wherein additionally, a desired region is selectable from the regions set by the region setter, and by targeting regions of the second image corresponding to all regions selected from the regions for white balance control, the white balance controller generates white-balance-adjusted images as many as the number equal to the number of the selected regions from the second image.

7. The imaging apparatus according to claim 6, further comprising:
a block divider that divides the first image into a plurality of blocks;
a white balance evaluation value obtainer that obtains a white balance evaluation value of each of the blocks of the first image; and
a white detection frame setter that sets a suitable white detection frame to each of the regions set by the region setter based on the white balance evaluation value with respect to the first image,
by use of suitable white detection frames set to the target regions by the white detection frame setter with respect to the second image, the white balance controller generates a white-balance-adjusted image based on color temperature of the regions of the second image corresponding to the regions set by the region setter, respectively, from the second image.

8. The imaging apparatus according to claim 7, wherein the white balance controller has a gain calculator that calculates a white balance gain by use of the white detection frame set by the white detection frame setter; and a white balance control image generator that generates a white-balance-adjusted image by use of the white balance gain calculated by the gain calculator from the second image.

9. The imaging apparatus according to claim 5, further comprising:
an exposure condition setter that sets an exposure condition to each of the regions of the first image set by the region setter; and
a photographing controller that obtains the second image as many as the number of the regions set by the region setter, by performing exposure control under each exposure condition set by the exposure condition setter,
wherein based on color temperature of each of the regions of the second image corresponding to each of the regions of the first image to which the exposure condition is set by the exposure condition setter, the white balance controller generates a white-balance-adjusted image from the second image.

10. The imaging apparatus according to claim 7, further comprising:
an exposure condition setter that sets an exposure condition to each of the regions of the first image set by the region setter; and
a photographing controller that obtains the second image as many as the number of the regions set by the region setter, by performing exposure control under each exposure condition set by the exposure condition setter,
wherein by use of a suitable white detection frame for each of the regions of the first image to which the exposure condition is set by the exposure condition setter with respect to each of the regions of the second image corresponding to each of the regions of the first image, based on color temperature of each of the regions of the second image, the white balance controller generates a white-balance-adjusted image suitable for the exposure condition set by the exposure condition setter.
